(19) United States
(12) Patent Application Publication
(10) Pub. No.: US 2018/0041437 A1
(43) Pub. Date: Feb. 8, 2018

(54) MANAGEMENT APPARATUS AND MANAGEMENT METHOD

(71) Applicant: FUJITSU LIMITED, Kawasaki-shi (JP)

(72) Inventors: Takamichi NISHIJIMA, Kawasaki (JP); Shinya KANO, Inagi (JP)

(73) Assignee: FUJITSU LIMITED, Kawasaki-shi (JP)

(21) Appl. No.: 15/646,643

(22) Filed: Jul. 11, 2017

(30) Foreign Application Priority Data
Aug. 4, 2016 (JP) 2016-153891

(51) Int. Cl. H04L 12/741; G06F 9/455; H04L 12/931; H04L 12/747; H04L 12/803

(52) U.S. Cl. CPC H04L 45/745; H04L 45/742; H04L 47/125; H04L 49/70; G06F 9/45558; G06F 2009/45595; G06F 2009/4557

(57) ABSTRACT

A management apparatus is configured to manage a processing load on a virtual machine of virtual machines forming a network, the management apparatus includes a memory, and a processor coupled to the memory and the processor configured to specify first virtual machines to perform a load distribution processing from the virtual machines, based on a type of first processing performed by the virtual machine and a sequence of which the first processing is performed, determine a destination of a transfer packet to be transferred to the first virtual machines at any of the first virtual machines, based on the processing load on the first virtual machines, in a case where the transfer packet is terminated by the first virtual machines, and transmit a first control packet including information of the determined destination of the transfer packet to a virtual machine of the virtual machines which generates the transfer packet.

### CROSS-REFERENCE TO RELATED APPLICATION

This application is based upon and claims the benefit of priority of the prior Japanese Patent Application No. 2016-153891, filed on Aug. 4, 2016, the entire contents of which are incorporated herein by reference.

### FIELD

The embodiments discussed herein are related to a management apparatus and a management method of a network.

### BACKGROUND

A technology referred to as a network functions virtualization (NFV) attracts attention. In the NFV, a function realized by a network device such as a router, a gateway, or a load balancer is implemented as an application program, and is operated as a virtual machine (VM) on a server. Moreover, a virtual machine providing a function used for communication through a network may be referred to as a virtual network function (VNF). In a system to which the network functions virtualization is applied, in order to selectively use a plurality of functions which operate in the virtual machine on the server, a data transfer channel (service chain) which becomes a channel of a packet processed by the function is generated.

FIG. 1 is a diagram illustrating an example of a system in which communication is performed by a service chain. The service chain is generated by a management server 10. First, a user such as a company 2 notifies the management server 10 of information such as a type of network function included in the service chain or a communication destination as a service demand (arrow A1). The management server 10 analyses the notified service demand, and performs deployment of a virtual machine which realizes the network function and a setting of a transfer channel in the virtual machine, by using a server 7 (7a to 7f) in a data center 4. In the example of FIG. 1, the data center 4 and the management server 10 are included in a wide area network 3.

A communication device in the company 2 performs communication by using the generated service chain. For example, the communication device in the company 2 accesses an Internet 5 through a service chain including a virtual machine VM1 which operates as a firewall (FW) and a virtual machine VM2 which operates as a Web Proxy. Furthermore, the communication device in the company 2 may communicate with a communication device in a base 6, through a service chain including a virtual machine VM3 which operates as a virtual private network (VPN) router. The service chain or the data center 4 illustrated in FIG. 1 is an example. The number of virtual machines in the service chain, the number of servers 7 installed in the data center 4, and the like may be optionally changed depending on implementation.

For example, in the communication of which a data transfer amount is large, as illustrated in FIG. 1, if the network function such as a firewall is processed by one virtual machine, there is a case where a processing speed demanded by the user may not be obtained. In such a case, it is possible to realize one network function by using a plurality of virtual machines, and to perform a load distribution between the virtual machines which realize the respective network functions.

FIG. 2 is a diagram illustrating an example of a service chain in which a load distribution between virtual machines is performed. In the service chain illustrated in FIG. 2, a Web Proxy is realized by two virtual machines, and a firewall is realized by four virtual machines. A function of a VPN router is realized by three virtual machines. Each of a plurality of virtual machines realizing one network function is connected to virtual machines VM11 to VM13 which operate as a load balancer (LB), and the load is distributed by the virtual machine which operates as a load balancer. For example, the virtual machine VM11 distributes packets to two virtual machines which operate as a Web Proxy. Similarly, the virtual machine VM12 distributes packets to four virtual machines which operate as a firewall, and the virtual machine VM13 distributes packets to three virtual machines which operate as a VPN router.

As a related technology, proposed is a network relay apparatus that includes a plurality of distributed processing units, and switches between a distributed processing mode and a centralized processing mode. In the distributed processing mode, each of the plurality of distributed processing units executes a destination search of a receiving packet, thereby, transfers the packet to an external apparatus, and in the centralized processing mode, each distributed processing unit transfers the packet to a centralized processing unit without executing the destination search of the receiving packet (for example, Japanese Laid-open Patent Publication No. 2010-109426). If a transfer target packet addressed to a predetermined virtual IP address is received, a system in which a destination is rewritten with an IP address which is assigned to any of a plurality of load distribution target servers specified based on the virtual IP address is also devised (for example, Japanese Laid-open Patent Publication No. 2003-174473).

### SUMMARY

According to an aspect of the invention, a management apparatus is configured to manage a processing load on a virtual machine of a plurality of virtual machines forming a network, the management apparatus includes a memory, and a processor coupled to the memory and the processor configured to specify a plurality of first virtual machines to perform a load distribution processing from the plurality of virtual machines, based on a type of first processing performed by the virtual machine and a sequence of which the first processing is performed, determine a destination of a transfer packet to be transferred to the plurality of first virtual machines at any of the plurality of first virtual machines, based on the processing load on the plurality of first virtual machines, in a case where the transfer packet is terminated by the plurality of first virtual machines, and transmit a first control packet including information of the determined destination of the transfer packet to a virtual machine of the plurality of virtual machines which generates the transfer packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system in which communication is performed by a service chain in the related art;

FIG. 2 is a diagram illustrating an example of a service chain in the related art;

FIG. 3A and FIG. 3B are diagrams illustrating an example of a control method according to an embodiment;

FIG. 4 is a diagram illustrating an example of a configuration of a management apparatus;

FIG. 5 is a diagram illustrating an example of a hardware configuration of the management apparatus;

FIG. 6 is a diagram illustrating a type of a load balancer;

FIG. 7 is a diagram illustrating an example of a service chain;

FIG. 8 is a flowchart illustrating an example of a search method of a VNF in a processing target;

FIG. 9 is a diagram illustrating an example of the service chain to which a first pattern is applied;

FIG. 10 is an example of a service chain demand and a network management table;

FIG. 11 is a diagram illustrating an example of an assignment method of a transfer destination;

FIG. 12 is a diagram illustrating a setting example of channel information;

FIG. 13 is a flowchart illustrating an example of a control method for performing a load distribution;

FIG. 14 is a flowchart illustrating an example of a determination method of a transfer destination of a packet;

FIG. 15 is a diagram illustrating an example of the service chain to which a second pattern is applied;

FIG. 16 is an example of the service chain demand and the network management table;

FIG. 17 is a diagram illustrating an example of the assignment method of the transfer destination;

FIG. 18 is a diagram illustrating a setting example of the channel information;

FIG. 19 is a diagram illustrating a setting example of an address in a distributed processing to a termination-type load balancer;

FIG. 20 is a diagram illustrating an example of the service chain to which a third pattern is applied;

FIG. 21 is an example of the service chain demand and the network management table;

FIG. 22 is a diagram illustrating an example of the assignment method of a destination of the packet;

FIG. 23 is a diagram illustrating an example of the assignment method of the transfer destination of the packet;

FIG. 24 is a diagram illustrating a setting example of the channel information;

FIG. 25 is a flowchart illustrating an example of the control method for performing the load distribution;

FIG. 26 is a diagram illustrating an example of the service chain to which a fourth pattern is applied;

FIG. 27 is an example of the service chain demand;

FIG. 28 is an example of the network management table;

FIG. 29 is a diagram illustrating an example of the assignment method of the destination of the packet;

FIG. 30 is a diagram illustrating an example of the assignment method of the transfer destination;

FIG. 31 is a diagram illustrating an example of the assignment method of the transfer destination;

FIG. 32 is a diagram illustrating a setting example of the channel information;

FIG. 33 is a diagram illustrating a setting example of the address in the distributed processing to a relay-type load balancer; and

FIG. 34 is a diagram illustrating a comparative example of the load distribution by the method according to the embodiment with other methods.

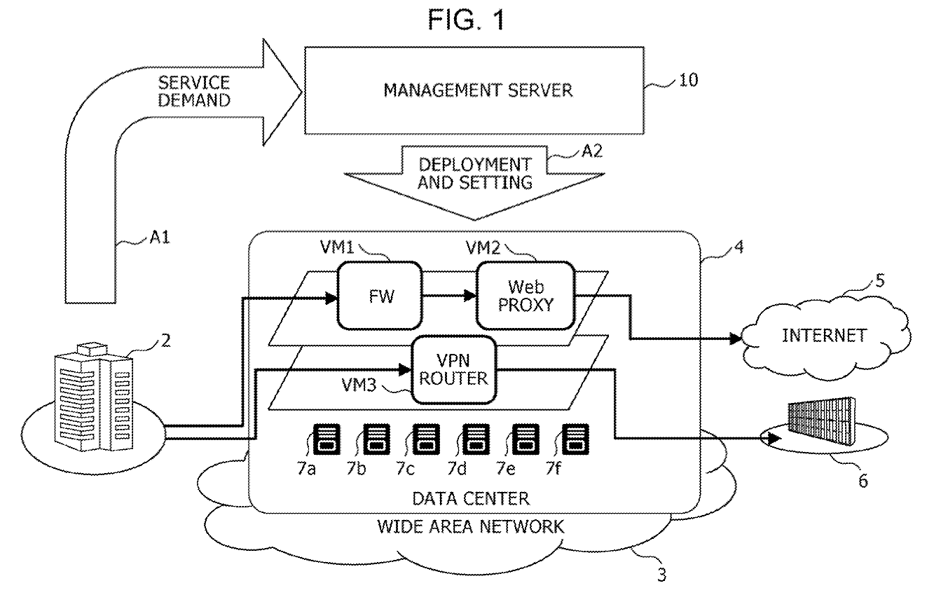

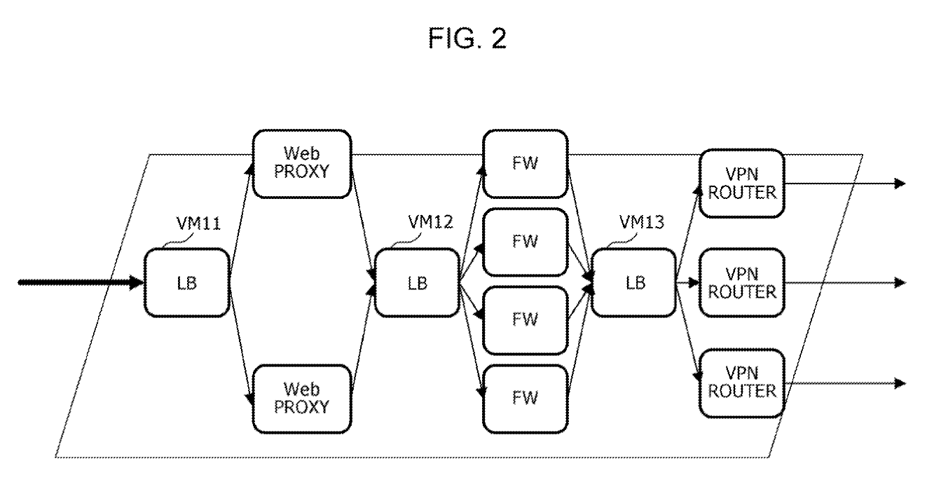

### DESCRIPTION OF EMBODIMENTS

Even if a processing in a portion of network functions is realized by a plurality of virtual machines, in a case where all packets in a service chain are concentrated on one virtual machine which operates as a load balancer, an upper limit of a transferable data amount is determined depending on the processed amount by the load balancer. Therefore, it is considered that the plurality of virtual machines are included in the network function which operates as a load balancer. However, a load may not be distributed among the plurality of virtual machines which operate as a load balancer, depending on a sequence or a combination of the network functions in the service chain. That is, a setting method of the service chain that may transfer the data of a large amount in general use regardless of the sequence or the combination of the network functions in the service chain, is not known.

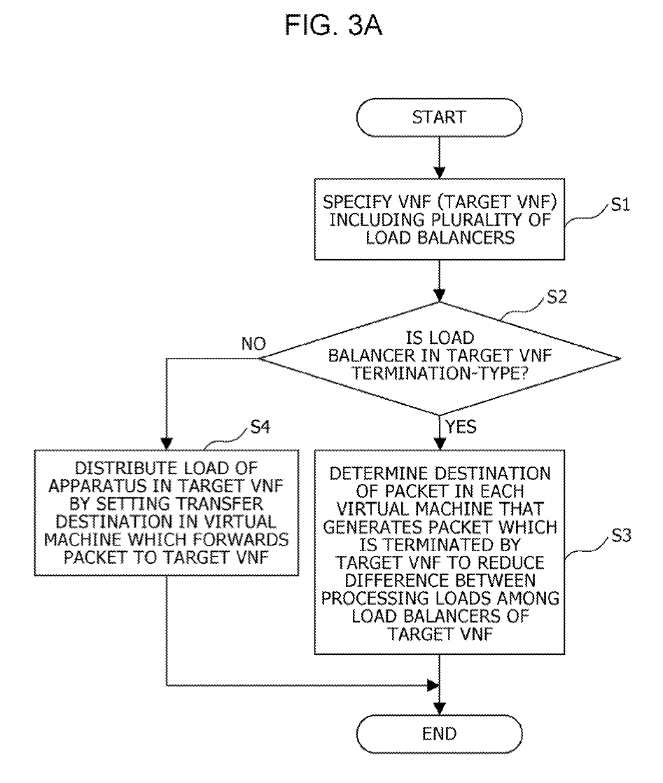

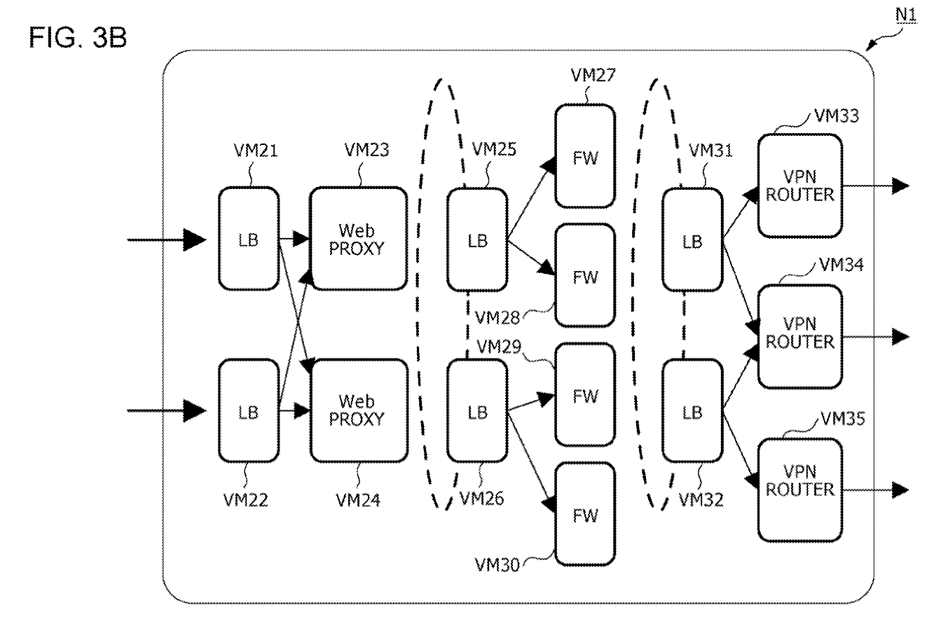

Embodiments of a technology providing a setting method of a channel which may transfer data of a large amount will be described by using the drawings. FIG. 3A and FIG. 3B are diagrams illustrating an example of a control method according to an embodiment. In a method according to the embodiment illustrated in a flowchart of FIG. 3A, a management apparatus which manages a service chain generates the service chain so that load distribution is possible among a plurality of virtual machines which operate as a load balancer. In operation S1, the management apparatus specifies a VNF including a plurality of load balancers as a target VNF. The management apparatus determines whether the load balancer in the target VNF is a termination-type (operation S2). Here, a termination-type device is a device that terminates a received packet. In a case where the target VNF is the termination-type, the management apparatus determines a destination of the packet in each virtual machine that generates the packet which is terminated by the target VNF so as to reduce a difference between processing loads among the load balancers included in the target VNF (Yes in operation S2, and operation S3). On the other hand, in a case where the target VNF is not the termination-type, the load balancer in the target VNF relays the received packet to the destination without terminating the received packet (No in operation S2). Therefore, the management apparatus distributes a load of the device in the target VNF, by setting a transfer destination of the packet in the virtual machine that transfers the packet to the target VNF (operation S4).

For example, in FIG. 3B, virtual machines VM21 to VM35 are included in a service chain illustrated in a network N1. The virtual machines VM23 and VM24 are included in one VNF which operates as a Web Proxy, and the virtual machines VM27 to VM30 are included in one VNF which operates as a firewall (FW). The virtual machines VM33 to VM35 are included in one VNF which operates as a VPN router.

All of the virtual machines VM21, VM22, VM25, VM26, VM31, and VM32 operate as a load balancer (LB). In the example of the network N1, the virtual machines VM21 and VM22 are included in a VNF that is disposed between the VNFs which operate as a transmission source and as a Web Proxy. The virtual machines VM25 and VM26 belong to a VNF that is disposed between the VNF which operates as a Web Proxy and the VNF which operates as a firewall. The virtual machines VM31 and VM32 belong to a VNF that is disposed between the VNF which operates as a firewall and the VNF which operates as a VPN router.

In a case where the VNF including the virtual machines VM25 and VM26 is set as a target VNF, the management apparatus determines whether the virtual machines VM25 and VM26 are termination-type load balancers. Here, it is assumed that the virtual machines VM25 and VM26 are the termination-type load balancers, and the packets terminated by the virtual machine VM25 or VM26 are generated by the virtual machines VM23 and VM24 which operate as a Web Proxy. Therefore, the management apparatus determines the destination of the packet generated by the Web Proxy VM23 and the destination of the packet generated by the Web Proxy VM24 so as to reduce the difference between the processing load on the virtual machine VM25 and the processing load on the virtual machine VM26. For example, the management apparatus sets the destination of the packet generated by the Web Proxy VM23 into the load balancer VM25, and sets the destination of the packet generated by the Web Proxy VM24 into the load balancer VM26.

On the other hand, in a case where the VNF including the virtual machines VM31 and VM32 is set as a target VNF, the management apparatus determines whether the virtual machines VM31 and VM32 are termination-type load balancers. Here, it is assumed that the virtual machines VM31 and VM32 are relay-type load balancers. The virtual machines that transfer the packets to the target VNF are VM27 to VM30 which operate as a firewall. Therefore, the management apparatus determines the transfer destination of the packet in the firewalls VM27 to VM30 so as to reduce the difference between the processing load on the virtual machine VM31 and the processing load on the virtual machine VM32, and sets information on the transfer destination into the firewalls VM27 to VM30. For example, the management apparatus sets the transfer destination of the packet in the firewalls VM27 to VM28 into the load balancer VM31, and sets the transfer destination of the packet in the firewalls VM29 to VM30 into the load balancer VM32. Here, the load balancer VM31 may transfer the packets to the VPN routers VM33 and VM34, and the load balancer VM32 may transfer the packets to the VPN routers VM34 and VM35. In a case where the transfer destination of the packet from the load balancers VM31 and VM32 is the termination-type VNF, the management apparatus sets the destination of the packet received by each load balancer so as to be an address that is assigned to the device to which the load balancer enables to transfer.

In this manner, depending on whether the plurality of load balancers included in one VNF terminate the packets, the management apparatus determines the setting in the virtual machine which is closer to the transmission source than the VNF which operates as a load balancer, thereby, distributes the load on the load balancer in the VNF. Therefore, in the method according to the embodiment, the service chain that is usable for transferring the data of a large amount may be automatically generated.

### Apparatus Configuration

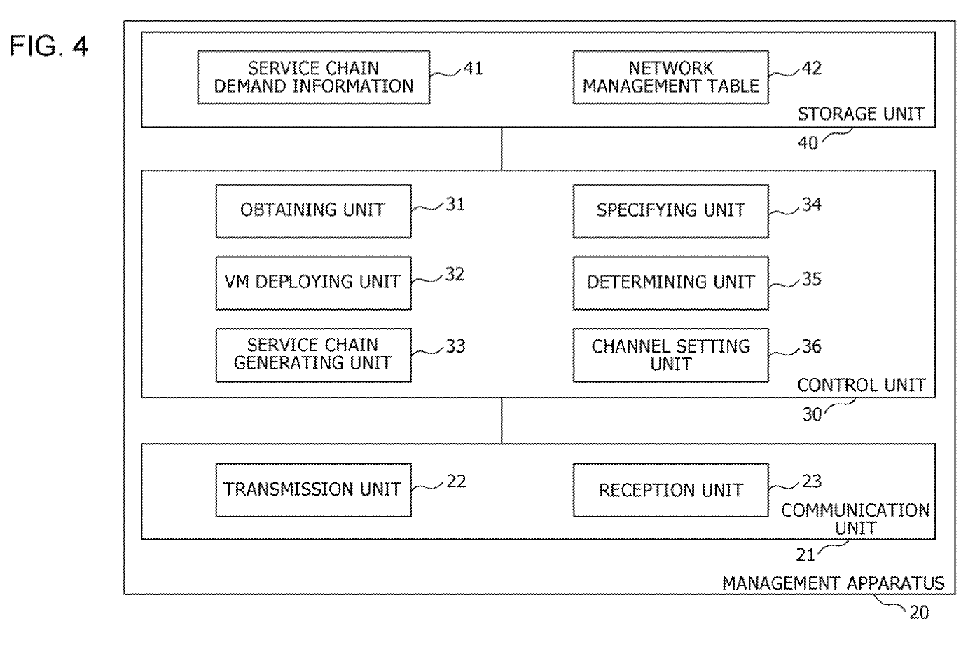

FIG. 4 is a diagram illustrating an example of a configuration of a management apparatus 20. The management apparatus 20 includes a communication unit 21, a control unit 30, and a storage unit 40. The communication unit 21 includes a transmission unit 22 and a reception unit 23. The control unit 30 includes an obtaining unit 31, a VM deploying unit 32, a service chain generating unit 33, a specifying unit 34, a determining unit 35, and a channel setting unit 36. The storage unit 40 includes a service chain demand information 41 and a network management table 42.

The transmission unit 22 transmits the packet to other devices such as the virtual machine in the VNF and a demand source device of generation of the service chain. The reception unit 23 receives the packet from other devices such as the virtual machine in the VNF and the demand source device of the generation of the service chain. At the time of transmitting the packet to the virtual machine and receiving the packet from the virtual machine, the packets are transmitted and received between a server 7 realizing the virtual machine and the management apparatus 20.

The obtaining unit 31 obtains information of the service chain from the packet received by the reception unit 23, and appropriately stores the information as the service chain demand information 41 in the storage unit 40. The VM deploying unit 32 performs activation of the virtual machine used in the service chain in which the generation is demanded. The service chain generating unit 33 performs a setting processing for realizing the VNF with respect to the virtual machine activated by the VM deploying unit 32. The service chain generating unit 33 records the information such as the information of each VNF and the address of the virtual machine included in each VNF in the network management table 42. The specifying unit 34 specifies the VNF including the plurality of load balancers among the VNFs included in the generated service chain. The specifying unit 34 also determines whether the load balancer in the specified VNF terminates the packet. By using the VNF specified by the specifying unit 34 and the determination result determined by the specifying unit 34, the determining unit 35 determines the setting of the transfer destination or the destination of the packet in the virtual machine which is included in the VNF on a transmission side of the packet than the VNF of a processing target. By using a processing result of the service chain generating unit 33 or the determining unit 35, the channel setting unit 36 sets a transfer channel in each virtual machine which is included in the service chain.

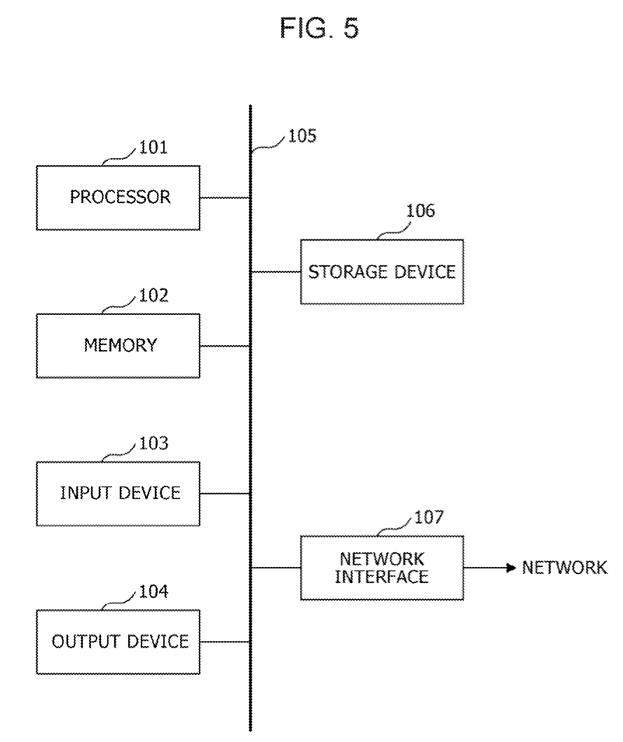

FIG. 5 is a diagram illustrating an example of a hardware configuration of the management apparatus 20. The management apparatus 20 includes a processor 101, a memory 102, a bus 105, a storage device 106, and a network interface 107. As an option, the management apparatus 20 may include an input device 103 and an output device 104. For example, the management apparatus 20 may be realized by a computer or the like.

The processor 101 may be a central processing unit (CPU) or any other optional processing circuit. The processor 101 executes various processing by using the memory 102 as a working memory and executing a program. The memory 102 includes a random access memory (RAM), and further includes a nonvolatile memory such as a read only memory (ROM). The memory 102 or the storage device 106 is used for storing the program or the data used in the processing in the processor 101. The network interface 107 is used for communication with other devices through the network. The network interface 107 may be a network interface card (NIC), a wireless local area network (LAN) card, or the like. An erasable programmable ROM (EPROM), a hard disk drive, or the like may be used as a storage device 106. The bus 105 connects the processor 101, the memory 102, the input device 103, the output device 104, the storage device 106, and the network interface 107 so that the data may be input and output to each other. For example, the input device 103 is realized as a button, a keyboard, or a mouse, and the output device 104 is realized as a display or the like.

As an option, the management apparatus 20 may include a portable storage medium drive device. The portable storage medium drive device may output the data in the memory 102 or the storage device 106 to a portable storage medium, and may read the programs, the data, or the like from the portable storage medium. Here, the portable storage medium is an optional storage medium which may be carried.

In the management apparatus 20, the processor 101 operates as a control unit 30. The memory 102 and the storage device 106 operate as a storage unit 40. The network interface 107 realizes the communication unit 21. The functions of the control unit 30 including some functions of the communication unit 21 may be realized by the processor 101.

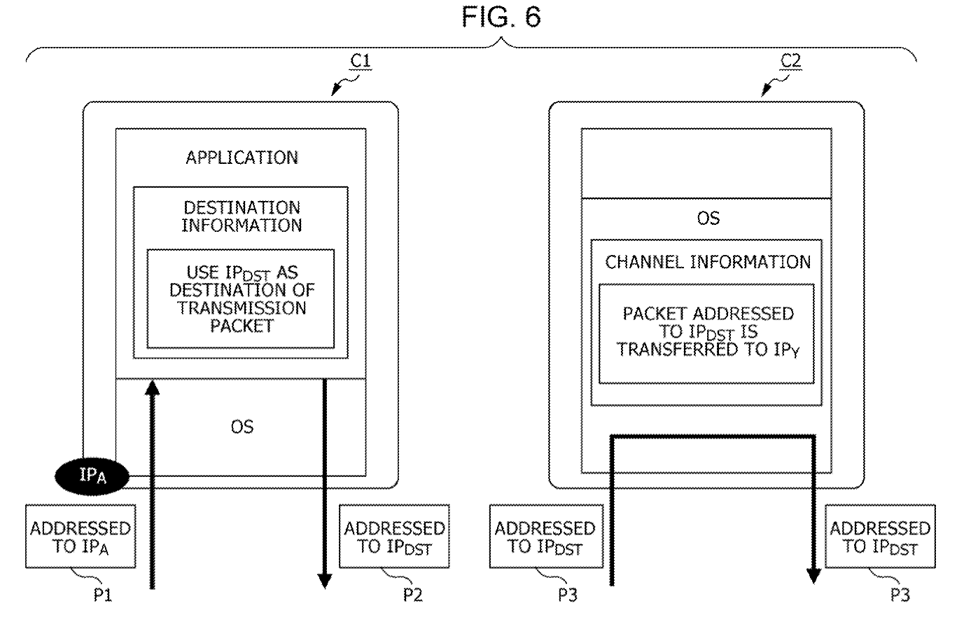

FIG. 6 is a diagram illustrating a type of load balancer. A case C1 illustrates an example of the processing of the load balancer that terminates the packet. The termination-type load balancer receives the packet of which the destination is set into the termination-type load balancer. The load balancer generates the packet of which the destination is set into the address written in the destination information that is set in order to be used in the communication of the service chain, and transmits the packet toward the destination. As destination information, a plurality of addresses which the load balancer may use as a division destination of the packet may be retained.

For example, in a case where an IP address referred to as an IP_{A} is assigned to the load balancer, the load balancer receives a packet P1 addressed to IP_{A}. The load balancer terminates the packet P1, and appropriately generates a transmission packet by using an application which operates on an operating system (OS). Here, information indicating that IP_{DST} is used as a destination of the transmission packet is selected in the destination information. Therefore, the load balancer generates a packet P2 addressed to the IP_{DST}, and transmits the packet P2 toward the destination.

A case C2 illustrates an example of the processing of the load balancer that relays the packet. The relay-type load balancer receives the packet of which the destination is set into other devices, and transfers the received packet depending on the channel information. In the channel information, destination address information is associated with address information that is assigned to a transfer destination device for transferring the packet to the destination thereof. The load balancer searches for a destination address in the channel information by using the destination address of the received packet as a key, and sets the device to which a relay address included in a hit entry is assigned as a transfer destination. In the channel information used by the load balancer, one or more relay addresses may be associated with one destination address. In this case, the load balancer selects the transfer destination from a plurality of candidates of the transfer destination so as to reduce the difference between the processing loads of a plurality of transfer destinations. The transfer processing of the load balancer may be performed by the OS.

For example, the load balancer receives a packet P3 addressed to IP_{DST}. Here, in the channel information, information indicating that the transfer destination in a case where the destination of the transmission packet is IP_{DST} is set into the device to which the IP_{Y} is assigned, is selected as the used information. Therefore, the load balancer transmits the packet P3 addressed to the IP_{DST} from a port that is connected to the device to which the IP_{Y} is assigned.

Hereinafter, the processing according to the embodiments will be described by being divided into a search for the processing target and a control for the load distribution.

### (A) Search Method of Processing Target

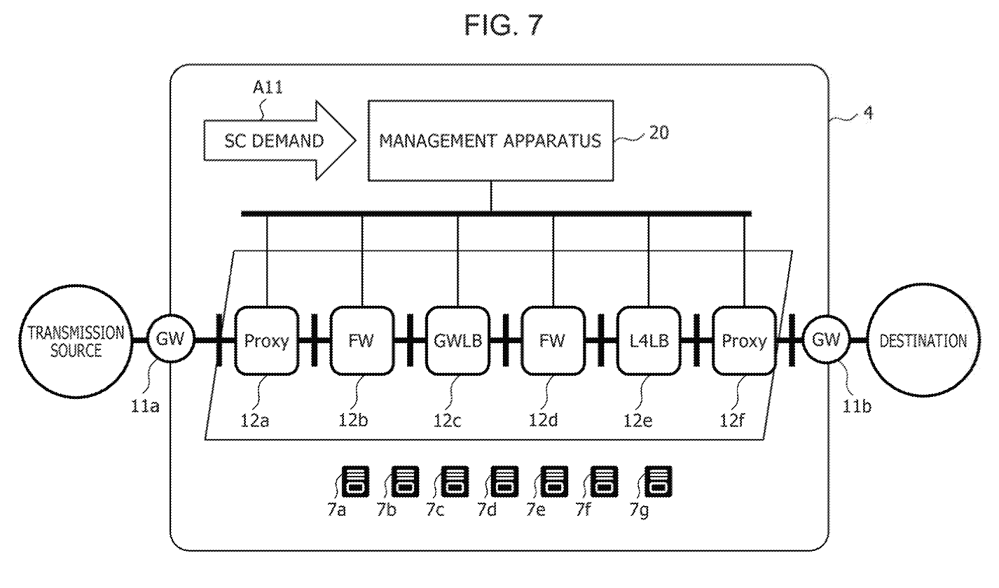

FIG. 7 is a diagram illustrating an example of the service chain. For example, the service chain demand is transmitted to the management apparatus 20, from a terminal or the like used by an user (arrow A11). Therefore, the management apparatus 20 appropriately generates the plurality of virtual machines by using the device which is selected from servers 7a to 7g included in the data center 4, and generates a VNF 12 (12a to 12f) which is demanded by the service chain demand. The service chain demanded by the arrow A11 is connected to a transmission source device through a gateway 11a. The VNF 12a operates as a termination-type Web Proxy, and the VNF 12b operates as a relay-type firewall (FW). The VNF 12c operates as a gateway-type load balancer (GWLB) which is one of the relay-type load balancers, and the VNF 12d operates as a relay-type firewall. The VNF 12e operates as a load balancer (L4LB) of a type that performs the processing of a layer 4 (L4) which is one of the termination-type load balancers, and the VNF 12f operates as a termination-type Web Proxy. The communication between the VNF 12f and a destination device is relayed by a gateway 11b. In each VNF 12, one or more virtual machines are included.

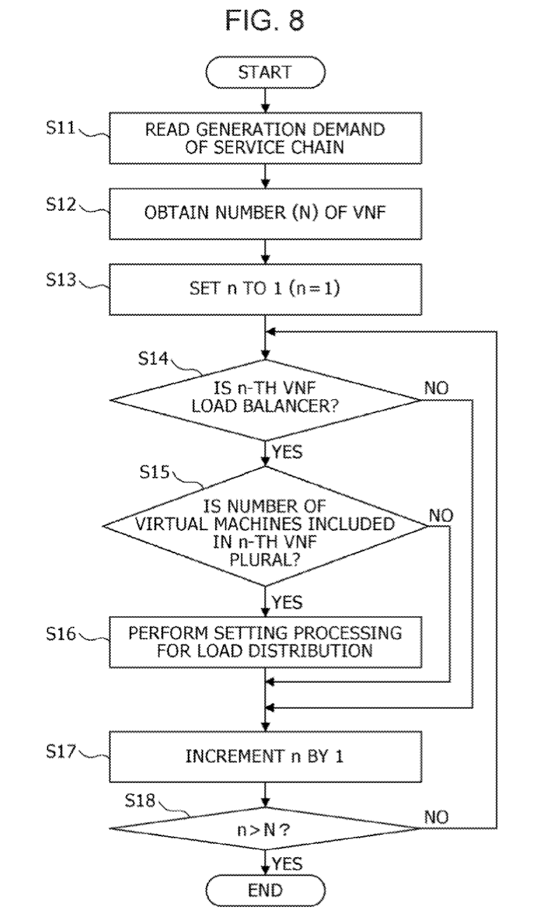

FIG. 8 is a flowchart illustrating an example of a method in which the management apparatus 20 searches for the VNF 12 in the processing target. In the example of FIG. 8, the VNF 12 of the processing target is the VNF 12 including the plurality of load balancers. In the example of FIG. 8, a variable n and a constant N are used. The constant N is a total number of VNFs in the service chain, and the variable n is a value that is used at the time of counting the number of VNFs 12 in which the specifying unit 34 performs a determination processing.

The obtaining unit 31 reads a generation demand of the service chain, from the packet or the like received by the reception unit 23 (operation S11). The obtaining unit 31 stores the read information in the service chain demand information 41. The specifying unit 34 obtains the number (N) of the VNFs 12 included in the service chain, from the service chain demand information 41 (operation S12). The specifying unit 34 sets the variable n to 1 (operation S13). The specifying unit 34 determines whether an n-th VNF 12 is the VNF 12 which operates as a load balancer (operation S14). In a case where the n-th VNF 12 is the VNF 12 which operates as a load balancer, the specifying unit 34 determines whether the number of virtual machines included in the n-th VNF 12 is plural (Yes in operation S14, and operation S15). In a case where the number of virtual machines included in the n-th VNF 12 is plural, the setting process for the load distribution among the load balancers in the n-th VNF 12 is performed by the determining unit 35 or the channel setting unit 36 (Yes in operation S15, and operation S16). Details of the processing performed in operation S16 will be described in detail in the description of a control example for the load distribution.

If the processing of operation S16 is completed, the specifying unit 34 increments the variable n by 1, and determines whether the variable n exceeds the constant N (operation S17, and operation S18). In a case where the variable n exceeds the constant N, the specifying unit 34 ends the processing (Yes in operation S18). On the other hand, in a case where the variable n does not exceed the constant N, the processing after operation S14 is performed (No in operation S18).

Even in a case where the n-th VNF 12 is not the load balancer (No in operation S14), the processing after operation S17 is performed. Furthermore, even in a case where the number of virtual machines included in the n-th VNF 12 which operates as a load balancer is not plural, the processing after operation S17 is performed (No in operation S15).

FIG. 8 is merely an example, and the processing may be changed depending on implementation. For example, the n-th VNF 12 may be the n-th VNF 12 by using the transmission source device as a standard, or may be the n-th VNF 12 by using the destination device as a standard.

### (B) Control Example for Load Distribution

Hereinafter, the control for the load distribution will be described by being divided into a case where the load balancer is the termination-type and a case where the load balancer is the relay-type. Furthermore, the respective cases will be described by being divided into a case where the VNF which operates as a load balancer is close to the termination-type VNF and a case where the VNF which operates as a load balancer is close to the relay-type VNF.

### (B1) First Pattern

In a first pattern, a case where the VNF 12 of the processing target is the termination-type load balancer and the VNF 12 that transfers the packet to the VNF 12 of the processing target is also the termination-type will be described.

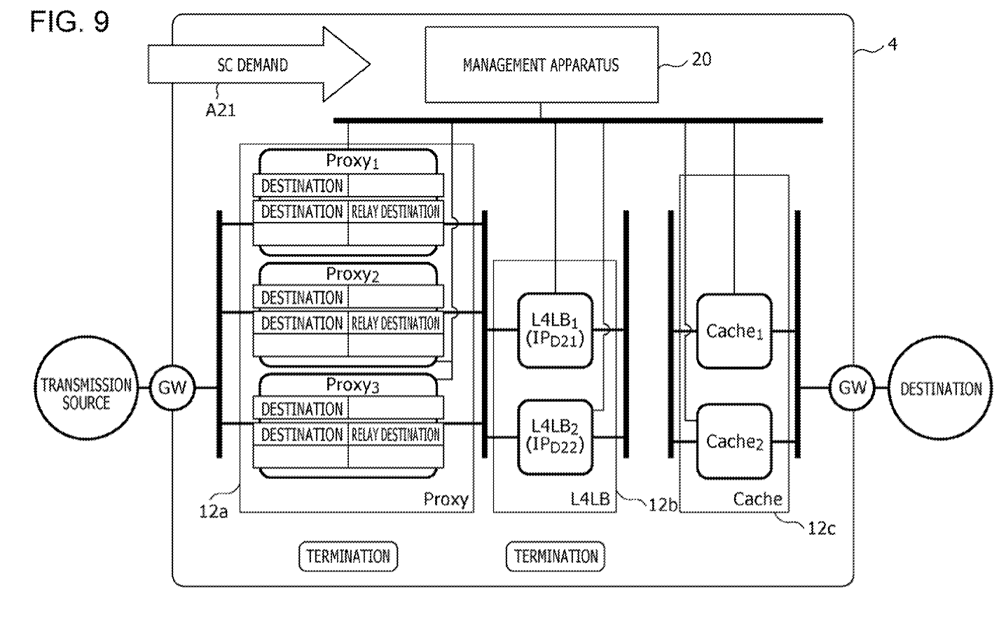

FIG. 9 is a diagram illustrating an example of the service chain to which the first pattern is applied. In the example of the service chain illustrating in FIG. 9, the VNF 12a that operates as a proxy, the VNF 12b that operates as a load balancer which processes the information of the layer 4, and the VNF 12c that operates as a cache are included in the service chain. The VNF 12a includes three virtual machines of Proxy₁ to Proxy₃, and the VNF 12b includes two virtual machines of L4LB₁ and L4LB₂. The VNF 12c includes two virtual machines of Cache₁ and Cache₂.

In the example of FIG. 9, the management apparatus 20 is included in the data center 4, and the service chain is generated by using the server 7 (not illustrated) in the data center 4. If the reception unit 23 receives a service chain demand (arrow A21) which is used in the first pattern, the VM deploying unit 32 or the service chain generating unit 33 in the management apparatus 20 generates the service chain illustrated in FIG. 9.

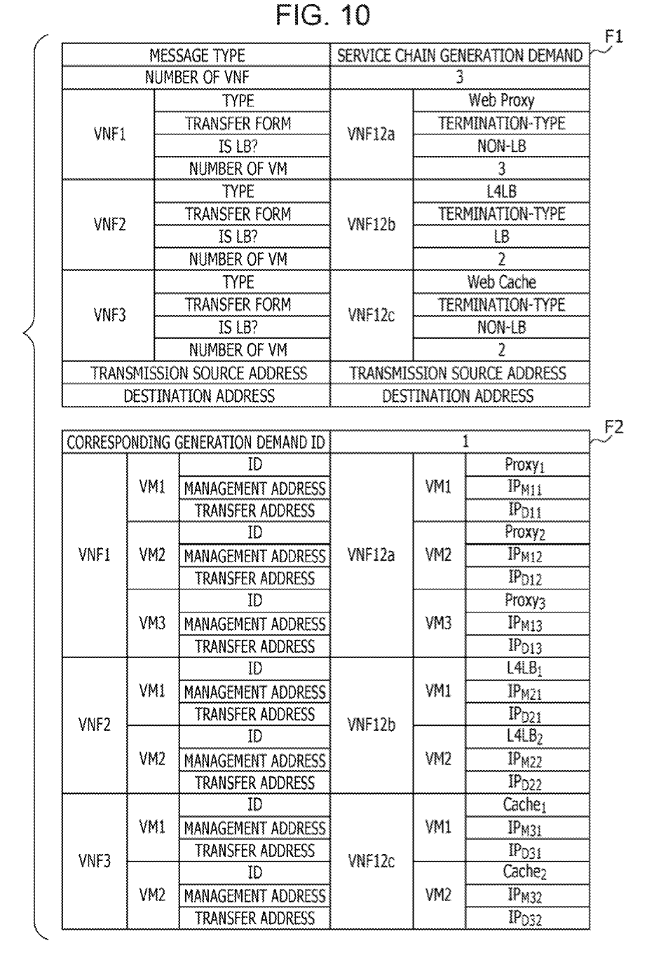

F1 of FIG. 10 is an example of the service chain demand transmitted by the arrow A21. In the service chain demand, a message type, the number of VNFs in the service chain, the information of each VNF 12, a transmission source address, and the destination address are included. The transmission source address is an address that is assigned to a communication device (transmission source device) which is positioned at an end point of the transmission source of the service chain. The destination address is an address that is assigned to a communication device (destination device) which is positioned at an end point of the destination of the service chain. The message type is set into the service chain demand. As information of each VNF 12, a type, a transfer form, a determination result obtained by determining whether to be a load balancer (LB), and the number of virtual machines (the number of VMs) which is included in the VNF 12 are included. Furthermore, the information of the VNF is written in a sequence which is close to the transmission source device. In the following description, in a column (left column) which describes information elements of the message, a numerical value written next to the VNF is a value indicating that the VNF is what-th VNF from the transmission source device. For example, the information of the VNF 12a is recorded as a VNF 1. In the example of F1, the VNF 12a operates as a Web Proxy, and the transfer form is the termination-type. It is determined that the VNF 12a is not the load balancer (non-LB), and the number of VMs in the VNF 12a is 3. The information of the VNF 12b is recorded as a VNF2. The VNF 12b operates as an L4LB, and the transfer form is the termination-type. The determination result regarding the VNF 12b is that the VNF 12b is the load balancer (LB), and the number of VMs in the VNF 12b is 2. The information of the VNF 12c is recorded as a VNF3. The VNF 12c operates as a Web Cache, and the transfer form is the termination-type. It is determined that the VNF 12c is not the load balancer (non-LB), and the number of VMs in the VNF 12c is 2.

If the obtaining unit 31 obtains the information illustrated in F1 of FIG. 10, the obtaining unit 31 records the obtained information in the service chain demand information 41 by associating information (generation demand ID) which identifies the generation demand with the obtained information. Here, the information illustrated in F1 is stored in the service chain demand information 41 in association with the information which is referred to as the generation demand ID=1. Since the service chain demand information 41 includes the information which is included in the service chain demand, in the following description, for convenience's sake of description, it may refer to F1 as information included in the service chain demand information 41.

The VM deploying unit 32 activates the virtual machine to the server 7 in the data center 4, with reference to the service chain demand information 41, and assigns an ID, a management address, and a transfer address to each virtual machine. Here, the management address is an IP address which is used for the communication between the management apparatus 20 and the virtual machine. The transfer address is an IP address which is used for transmitting and receiving data in the service chain. The VM deploying unit 32 records the assigned IP address or ID in the network management table 42, regarding each virtual machine. In the network management table 42, the generation demand ID for identifying the generation demand which is used in the generation of the service chain is also included. In the drawing of the virtual machine illustrated in FIG. 9, the ID which is determined with respect to each virtual machine is written.

F2 in FIG. 10 is an example of the network management table 42. Hereinafter, the addresses that are assigned to each of the virtual machines which are included in the VNF 12a to the VNF 12c are illustrated in F2. For example, in the virtual machine Proxy₁, the management address is IP_{M11}, and the transfer address is IP_{D11}. In the virtual machine Proxy₂, the management address is IP_{M12}, and the transfer address is IP_{D12}, and in the virtual machine Proxy₃, the management address is IP_{M13}, and the transfer address is IP_{D13}. In the virtual machine L4LB₁ included in the VNF 12b, the management address is IP_{M21}, and the transfer address is IP_{D21}. In the virtual machine L4LB₂, the management address is IP_{M22}, and the transfer address is IP_{D22}. Similarly, in the virtual machine Cache₁ included in the VNF 12c, the management address is IP_{M31}, and the transfer address is IP_{D31}. In the virtual machine Cache₂, the management address is IP_{M32}, and the transfer address is IP_{D32}.

The specifying unit 34 specifies the VNF 12 including the plurality of load balancers which become the target of the load distribution by the processing described with reference to FIG. 7 and FIG. 8. In the example of the network illustrated in FIG. 9, the specifying unit 34 specifies the VNF 12b as a processing target with reference to the service chain demand information 41 (including the information of F1 in FIG. 10). At this time, the specifying unit 34 also specifies that the VNF 12b is the termination-type. Therefore, the specifying unit 34 specifies the VNF 12 including the device that generates the packet which is terminated by the VNF 12b, by using the service chain demand information 41. At this time, the specifying unit 34 refers to the transfer form of the VNF 12 which is closer to the transmission source device than the VNF 12b of the processing target, in the information of the service chain demand information 41. In F1 of FIG. 10, since the VNF 12a which is closer to the transmission source device than the VNF 12b is the termination-type, the specifying unit 34 determines that the virtual machine in the VNF 12a generates the packet which is terminated by the VNF 12b. The specifying unit 34 notifies the determining unit 35 of the obtained result.

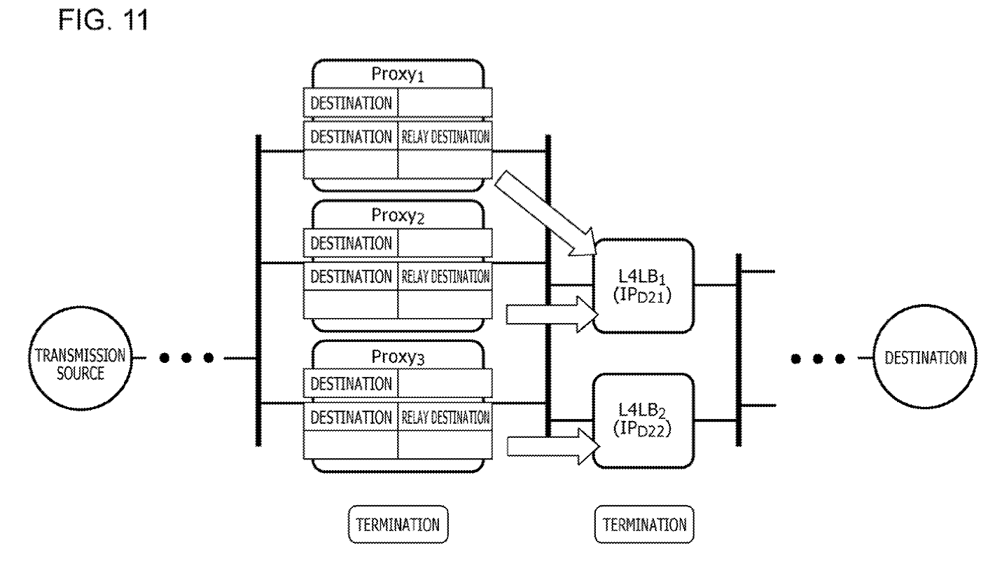

FIG. 11 is a diagram illustrating an example of an assignment method of the transfer destination. With reference to FIG. 11, an example of the processing of the determining unit 35 in a case of being notified of that the packet generated by the virtual machine in the VNF 12a is terminated by the VNF 12b which operates as a load balancer will be described. FIG. 11 illustrates a case where the VNF 12a and the VNF 12b are extracted from the service chain of FIG. 9. By using the service chain demand information 41, the determining unit 35 recognizes that three virtual machines of the Proxy₁ to the Proxy₃ are included in the VNF 12a, and two virtual machines of the L4LB₁ and the L4LB₂ are included in the VNF 12b. The determining unit 35 determines the destinations of the packets which are generated by the Proxy₁ to the Proxy₃ so as to minimize the difference between the processing loads of the L4LB₁ and the L4LB₂. In the example of FIG. 11, the determining unit 35 determines that the destinations of the packets generated by the Proxy₁ and the Proxy₂ are set into the L4LB₁, and the destination of the packet generated by the Proxy₃ is set into the L4LB₂. Therefore, the determining unit 35 determines the destinations of the packets generated by the Proxy1 and the Proxy2 as IP_{D21}, and determines the destination of the packet generated by the Proxy3 as IP_{D22}. The determining unit 35 also determines the information such as a relay destination set into a routing table which is used in the VNF 12a, depending on the information of the destination of the packet in the VNF 12a. The determining unit 35 outputs the determined information to the channel setting unit 36.

The channel setting unit 36 generates a control packet for notifying each of the virtual machines in the VNF 12a of the information which is input from the determining unit 35. For example, in the control packet addressed to the Proxy₁ and the control packet addressed to the Proxy₂, the following information is included.
Destination of the generated packet:IP_{D21}
Destination in the routing table:IP_{D21}
Relay destination in the routing table:IP_{D21}

On the other hand, in the control packet addressed to the Proxy₃, the following information is included.
Destination of the generated packet:IP_{D22}
Destination in the routing table:IP_{D22}
Relay destination in the routing table:IP_{D22}
   The channel setting unit 36 transmits the control packets to each of the Proxy₁ to the Proxy₃ through the transmission unit 22. At the time of transmitting the control packet, the management address assigned to each virtual machine is used.

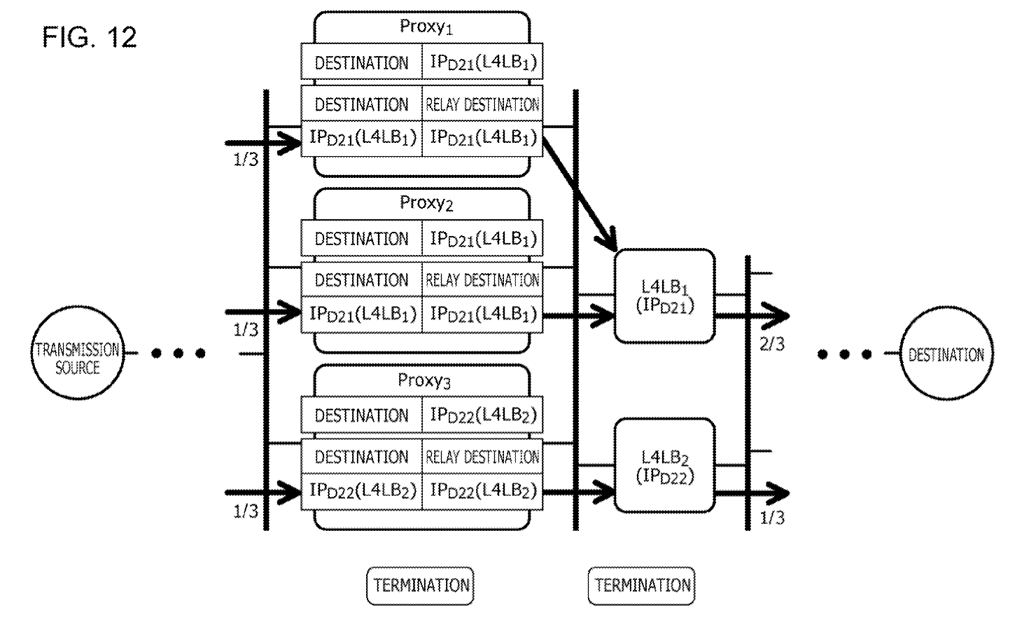

FIG. 12 is a diagram illustrating a setting example of the channel information. Each of the virtual machines that receive the control packets from the management apparatus 20 sets the destination information of the generated packet and the routing table, in accordance with the control packet. In the example of FIG. 12, in order to easily understood, in succession of the address, the ID of the virtual machine to which the address thereof is assigned is written in parentheses. By performing the setting processing as illustrated in FIG. 12, in the generated service chain, the packets generated by the Proxy₁ and the Proxy₂ are transmitted to the L4LB₁, and the packet generated by the Proxy₃ is transmitted to the L4LB₂.

Here, in a case where the amount of the data transmitted from the transmission source is the same as those of the Proxy₁ to the Proxy₃, the amount of the data which is obtained from the transmission source by each of the Proxy₁ to the Proxy₃ is ⅓ of the amount of the data transmitted from the transmission source, one by one. Therefore, the data processed by the L4LB₁ is approximately ⅔ of the transmitted data, and the data processed by the L4LB₂ is approximately ⅓ of the transmitted data.

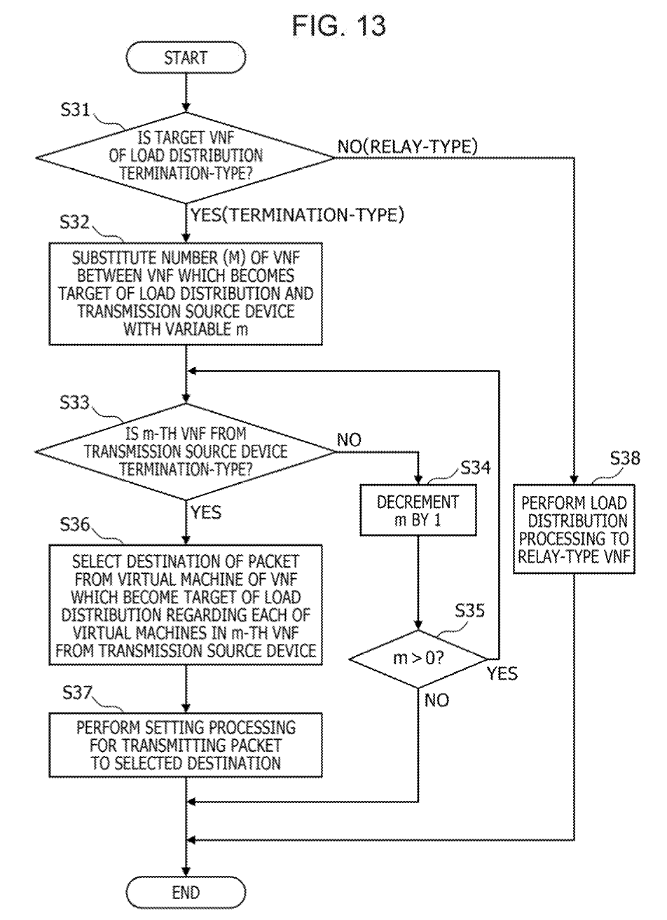

FIG. 13 is a flowchart illustrating an example of a control method for performing the load distribution, and represents the details of the processing in operation S16 of FIG. 8. In FIG. 13, a constant M and a variable m are used. The constant M is a total number of the VNFs 12 through which the packet passes to the VNF 12 which becomes the target of the load distribution from the transmission source device. The transmission source device is a transmission source device of the data transmitted and received by the service chain, in the end point of the service chain. The variable m is a variable which is used in the processing by the specifying unit 34.

The specifying unit 34 specifies the VNF 12 which is the target of the load distribution, by the processing described with reference to operations S11 to S15 of FIG. 8. The specifying unit 34 determines whether the VNF 12 which becomes the target of the load distribution is the termination-type (operation S31). In a case where the VNF 12 which is the target of the load distribution is the termination-type, the specifying unit 34 substitutes the number (M) of the VNFs 12 that are between the VNF 12 which becomes the target of the load distribution and the transmission source device with the variable m (operation S32). The specifying unit 34 determines whether an m-th VNF 12 from the transmission source device is the termination-type (operation S33). In a case where the m-th VNF 12 from the transmission source device is not the termination-type, the specifying unit 34 decrements the variable m by 1, and determines whether the variable m is larger than 0 (No in operation S33, and operations S34 and S35). In a case where the variable m is larger than 0, the processing after the operation S33 is performed.

In a case where the m-th VNF 12 from the transmission source device is the termination-type, the determining unit 35 selects the destination of the packet from the virtual machine of the VNF 12 which becomes the target of the load distribution, regarding each of the virtual machines of the m-th VNF 12 from the transmission source device (Yes in operation S33, and operation S36). The determining unit 35 and the channel setting unit 36 perform the setting processing for transmitting the packet by each of the virtual machines included in the m-th VNF 12 to the destination which is selected by the determining unit 35 (operation S37).

On the other hand, in operation S31, in a case where it is determined that the VNF 12 which is the target of the load distribution is not the termination-type, a load distribution processing is performed with respect to the relay-type VNF 12 (No in operation S31, and operation S38).

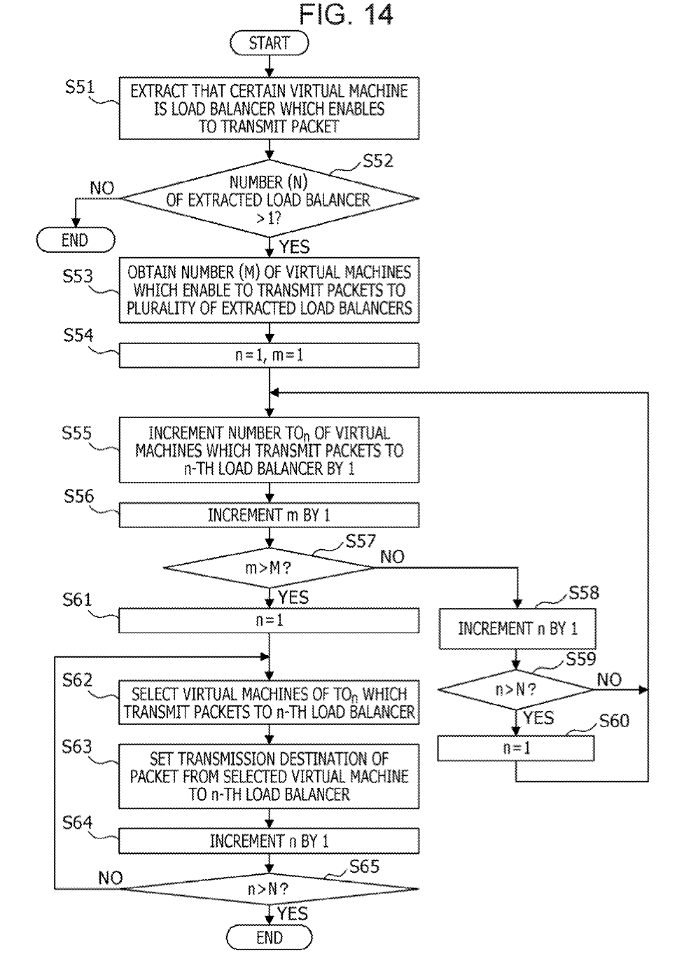

FIG. 14 is a flowchart illustrating an example of a determination method of the transfer destination of the packet. FIG. 14 is an example of the details of the processing of operations S36 and S37 of FIG. 13. In FIG. 14, the variable n and the variable m are used. The variable n is used for counting the number of load balancers which become the processing targets, and the variable m is used for counting the number of virtual machines which become the processing targets.

The determining unit 35 extracts that one of the virtual machines that generate the packets terminated by the load balancer is the load balancer which enables to transmit the packet (operation S51). The determining unit 35 determines whether the number of extracted load balancers is larger than 1 (operation S52). In a case where the number (constant N) of extracted load balancers is equal to or less than 1, the determining unit 35 ends the processing (No in operation S52). In a case where the number of extracted load balancers is larger than 1, the determining unit 35 obtains the number (constant M) of virtual machines that enable to transmit the packets to a plurality of extracted load balancers (Yes in operation S52, and operation S53). The determining unit 35 sets both of the variable m and the variable n to 1 (operation S54).

The determining unit 35 increments the number TOₙ of virtual machines which transmit the packets to the n-th load balancer by 1 (operation S55). The determining unit 35 increments the variable m by 1, and determines whether the variable m exceeds the constant M (operations S56 and S57). In a case where the variable m does not exceed the constant M, the determining unit 35 increments the variable n by 1, and determines whether the variable n exceeds the constant N (No in operation S57, and operations S58 and S59). In a case where the variable n does not exceed the constant N, the determining unit 35 repeats the processing after operation S55 (No in operation S59). In a case where the variable n exceeds the constant N, the determining unit 35 returns the variable n to 1, and repeats the processing after operation S55 (Yes in operation S59, and operation S60). In the processing of operations S55 to S60, the virtual machine is assigned to each load balancer until the value of m becomes the same as the number of virtual machines that enable to transmit the packets to the load balancer which is extracted in operation S51. In the processing of operations S55 to S60, the assignment of the virtual machine to the load balancer is performed in a round robin manner, but the processing is merely an example, and may be changed depending on implementation.

In operation S57, if it is determined that the variable m exceeds the constant M, the determining unit 35 changes the variable n into 1 (Yes in operation S57, and operation S61). The determining unit 35 selects the virtual machines of TOn which transmit the packets to the n-th load balancer, from the virtual machines extracted in operation S53 (operation S62). The channel setting unit 36 sets the destination of the packet that is transmitted by the virtual machine which is selected by the determining unit 35 into the n-th load balancer, by using the control packet (operation S63). The channel setting unit 36 increments the variable n by 1, and determines whether the variable n exceeds the constant N (operations S64 and S65). In a case where the variable n does not exceed the constant N, the processing after operation S62 is repeated (No in operation S65). If the variable n exceeds the constant N, the determining unit 35 and the channel setting unit 36 end the processing (Yes in operation S65).

### (B2) Second Pattern

In a second pattern, a case where the VNF 12 which is the target of the load distribution is the termination-type load balancer, but the VNF 12 that transfers the packet to the VNF 12 which is the target of the load distribution is the relay-type will be described.

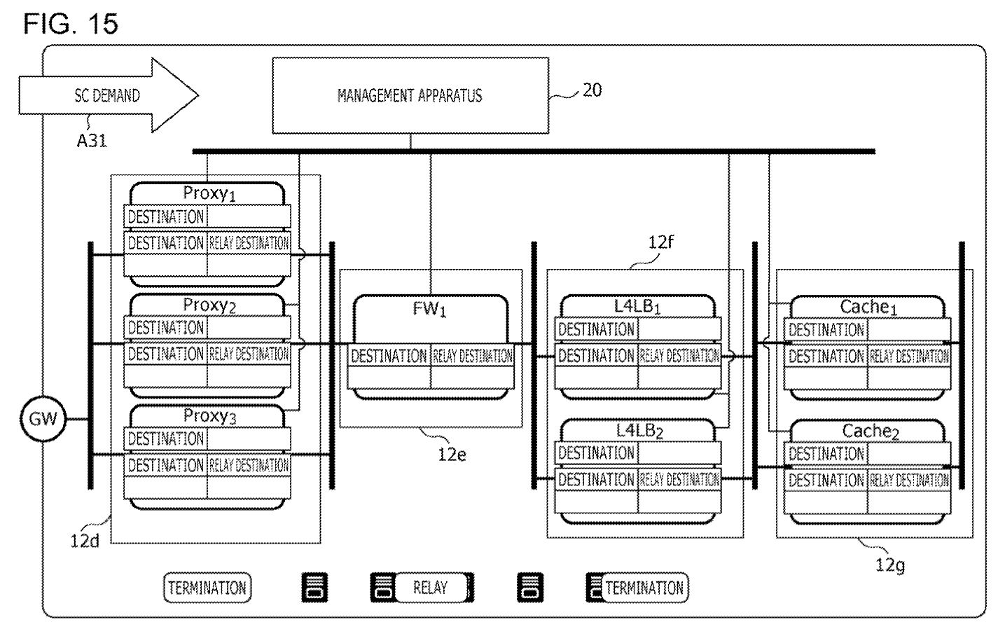

FIG. 15 is a diagram illustrating an example of the service chain to which the second pattern is applied. The service chain illustrated in FIG. 15 includes the VNFs of 12d to 12g. In the following description, the VNF 12d operates as a proxy, and the VNF 12e operates as a firewall. The VNF 12f operates as a load balancer (L4LB) that processes the information of the layer 4, and the VNF 12g operates as a cache. The VNF 12d includes three virtual machines of the Proxy₁ to the Proxy₃, and the VNF 12e includes a FW₁. The VNF 12f includes two virtual machines of the L4LB₁ and the L4LB₂. The VNF 12g includes two virtual machines of the Cache₁ and the Cache₂.

In the example of FIG. 15, if the reception unit 23 receives a service chain demand (arrow A31) which is used in the second pattern, the management apparatus 20 generates the service chain illustrated in FIG. 15.

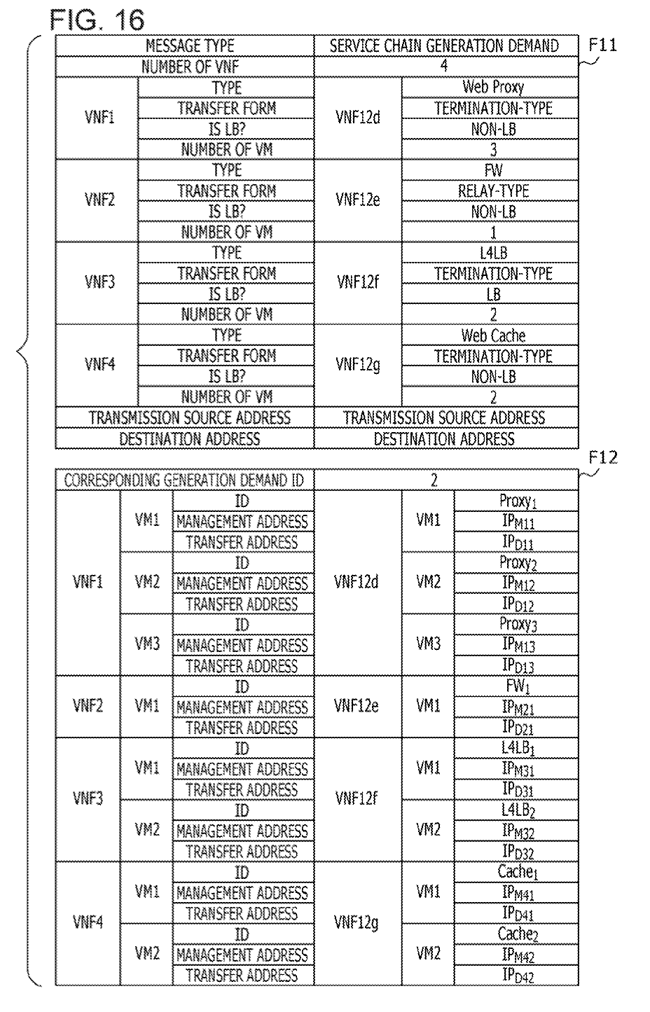

F11 of FIG. 16 is an example of the service chain demand transmitted by the arrow A31. In F11, in a sequence which is close to the transmission source device, the generating of four VNFs 12 of the VNF 12d, the VNF 12e, the VNF 12f, and the VNF 12g is demanded, and the information of each VNF 12 is included. The information of the VNF 12d is recorded as a VNF 1. In the example of F11, the VNF 12d operates as a Web Proxy, and the transfer form is the termination-type. It is determined that the VNF 12d is not the load balancer (non-LB), and the number of VMs of the VNF 12d is 3. The information of the VNF 12e is recorded as a VNF 2. The VNF 12e operates as a firewall, and the transfer form is the relay-type. It is determined that the VNF 12e is not the load balancer (non-LB), and the number of VMs of the VNF 12e is 1. The information of the VNF 12f is recorded as a VNF 3. The VNF 12f operates as a load balancer, and the transfer form is the termination-type. The determination result regarding the VNF 12f is to be the load balancer (LB), and the number of VMs of the VNF 12f is 2. The information of the VNF 12g is recorded as a VNF 4. The VNF 12g operates as a Web Cache, and the transfer form is the termination-type. It is determined that the VNF 12g is not the load balancer (non-LB), and the number of VMs of the VNF 12g is 2.

If the information illustrated in F11 of FIG. 16 is obtained, the obtaining unit 31 stores the obtained information in the service chain demand information 41 by associating the obtained information with the information as the generation demand ID=2.

The VM deploying unit 32 generates the virtual machine, and performs the setting, by the same processing as the processing described in the first pattern, and records the information of the service chain in the network management table 42. In the drawing of the virtual machine illustrated in FIG. 15, the ID which is determined with respect to each virtual machine is written.

F12 of FIG. 16 is an example of the network management table 42. Hereinafter, the addresses assigned to each of the virtual machines which are included in the VNF 12d to the VNF 12g are illustrated in F12. For example, in the virtual machine Proxy₁, the management address is IP_{M11}, and the transfer address is IP_{D11}. In the virtual machine Cache₁ which is included in the VNF 12g, the management address is IP_{M41}, and the transfer address is IP_{D41}.

The specifying unit 34 specifies the VNF 12 including the plurality of load balancers which become the targets of the load distribution, by the same processing as the processing described with reference to FIG. 7 and FIG. 8. In the example of the network illustrated in FIG. 15, the specifying unit 34 specifies the VNF 12f as a processing target, with reference to the service chain demand information 41 including the information illustrated in F11 of FIG. 16. At this time, the specifying unit 34 also specifies that the VNF 12f is the termination-type. Next, the specifying unit 34 specifies that the packet which is terminated by the VNF 12f is generated by the VNF 12d, and the VNF 12e which is adjacent to the VNF 12f is the relay-type, by the same processing as the processing described with reference to FIG. 13.

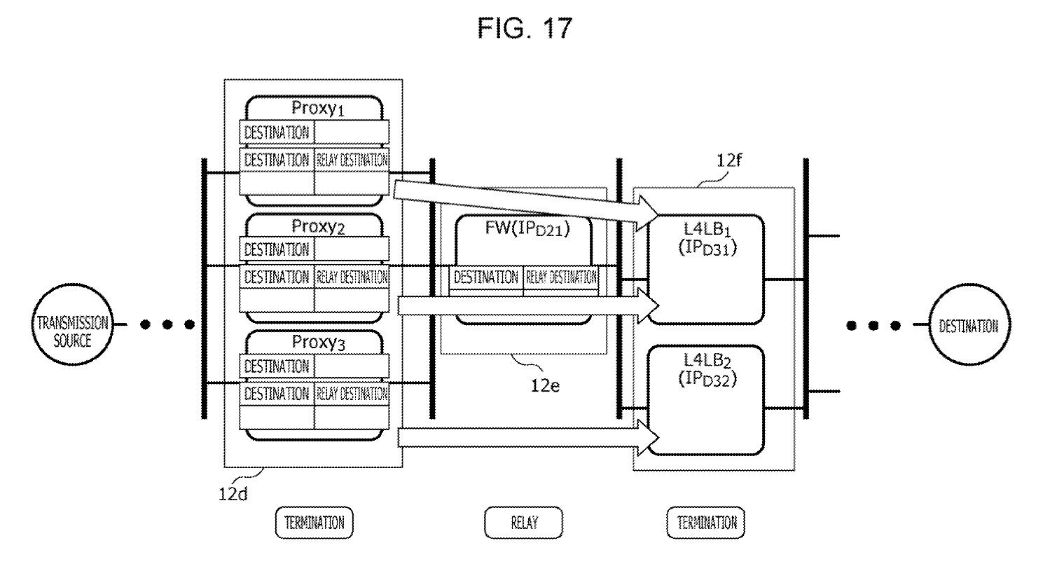

FIG. 17 is a diagram illustrating an example of the assignment method of the transfer destination. With reference to FIG. 17, an example of the processing of the determining unit 35 in a case of being notified of that the packet generated by the virtual machine in the VNF 12d is terminated by the VNF 12f which operates as a load balancer will be described. FIG. 17 illustrates a case where the VNF 12d, the VNF 12e, and the VNF 12f are extracted from the service chain of FIG. 15. By using the service chain demand information 41, the determining unit 35 recognizes that three virtual machines of the Proxy₁ to the Proxy₃ are included in the VNF 12d, and one virtual machine identified by ID=FW₁ is included in the VNF 12e. The determining unit 35 recognizes that two virtual machines of the L4LB₁ and the L4LB₂ are included in the VNF 12f.

The determining unit 35 determines the destinations of the packets which are generated by the Proxy₁ to the Proxy₃ so as to minimize the difference between the processing loads of the L4LB₁ and the L4LB₂, even in a case where the relay-type VNF 12e is included between the VNF 12d which generates the packet and the VNF 12f which terminates the packet. In the example of FIG. 17, the determining unit 35 determines that the destinations of the packets generated by the Proxy₁ and the Proxy₂ are set into the L4LB₁, and the destination of the packet generated by the Proxy₃ is set into the L4LB₂, in the same manner as the first pattern. In this case, the determining unit 35 determines the destinations of the packets generated by the Proxy₁ and the Proxy₂ as IP_{D31}, and determines the destination of the packet generated by the Proxy₃ as IP_{D32}. The determining unit 35 determines the information such as the relay destination set into the routing table which is used in the VNF 12d, and the information of the routing table which is used in the VNF 12e, depending on the information of the destination of the packet in the VNF 12d. The determining unit 35 outputs the determined information to the channel setting unit 36.

The channel setting unit 36 generates the control packet for notifying each virtual machine of the information which is input from the determining unit 35. For example, in the control packet addressed to the Proxy₁ and the control packet addressed to the Proxy₂ in the VNF 12d, the following information is included.
Destination of the generated packet:IP_{D31}
Destination in the routing table:IP_{D31}
Relay destination in the routing table:IP_{D21}

On the other hand, in the control packet addressed to the Proxy₃ in the VNF 12d, the following information is included.
Destination of the generated packet:IP_{D32}
Destination in the routing table:IP_{D32}
Relay destination in the routing table:IP_{D21}

In the control packet addressed to the FW₁ in the VNF 12e, the following information is included.
Destination 1:IP_{D31}
Relay destination of the packet addressed to the destination 1:IP_{D31}
Destination 2:IP_{D32}
Relay destination of the packet addressed to the destination 2:IP_{D32}
   The channel setting unit 36 transmits the control packets to each of the Proxy₁ to the Proxy₃, and the FW₁ through the transmission unit 22.

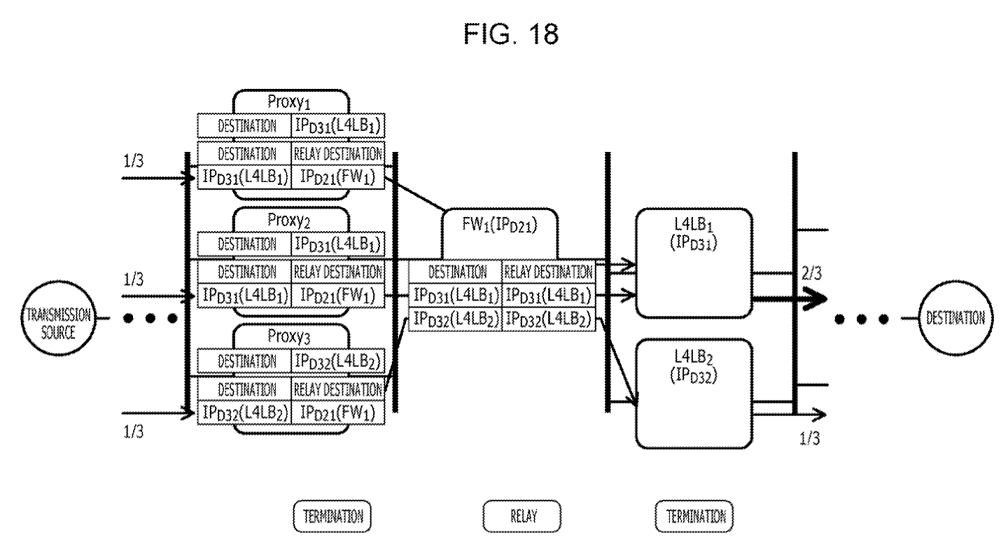

FIG. 18 is a diagram illustrating a setting example of the channel information. Each of the virtual machines that receive the control packets from the management apparatus 20 sets the destination information of the generated packet and the routing table, in accordance with the control packet. In the example of FIG. 18, in succession of the address, the ID of the virtual machine to which the address thereof is assigned is written in parentheses. By performing the setting processing as illustrated in FIG. 18, in the generated service chain, the packet generated by any of the Proxy₁ to the Proxy₃ is transmitted to the FW₁. By using the routing table, the FW₁ relays the packets generated by the Proxy₁ and the Proxy₂ to the L4LB₁, and relays the packet generated by the Proxy₃ to the L4LB₂. Therefore, in the same manner as the first pattern, the load distribution is performed between each of the virtual machines in the VNF 12 including the plurality of load balancers, even in the second pattern. That is, in a case where the amounts of the processed data of the Proxy₁ to the Proxy₃ are substantially the same, the L4LB₁ processes ⅔ of the data which is processed in the service chain, and L4LB₂ processes ⅓ of the data which is processed in the service chain.

### (B3) Summary of Setting to Termination-Type Load Balancer

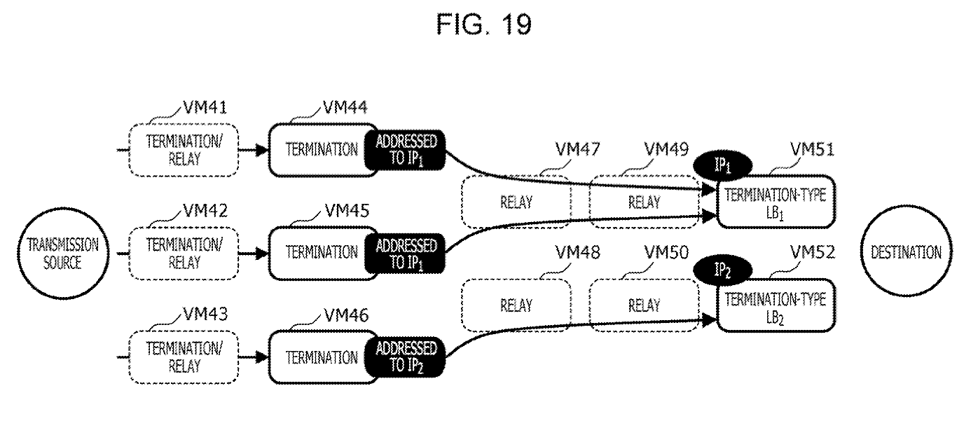

FIG. 19 is a diagram illustrating a setting example of the address in the distributed processing to the termination-type load balancer. In FIG. 19, a virtual machine relating to the setting of the destination at the time of the processing for the load distribution in the VNF 12 which includes the plurality of virtual machines and operates as a termination-type load balancer, is indicated by a solid line, and other virtual machines are indicated by dotted lines. Therefore, among the virtual machines VM41 to VM52, the VM47 to the VM50 which are not the termination-type are indicated by dotted lines.

As described with reference to FIG. 9 to FIG. 18, by setting the destination of the packet of the virtual machine in the VNF 12 that generates the packet which is terminated by the termination-type load balancer, the load distribution of the virtual machine in the VNF 12 which operates as a termination-type load balancer is possible. This is similarly applied to a case where the VNF 12 which is adjacent to the VNF 12 which operates as a termination-type load balancer is any of the termination-type and the relay-type. Therefore, by setting the destinations of the packets generated by the virtual machines VM44, VM45, and VM46 which perform the termination-type processing, the load distribution of the VM51 and the VM52 which operate as a load balancer is possible. For example, in a case where the destination address of the packet generated in the virtual machines VM44 and VM45 is IP₁, and the destination address of the packet generated in the virtual machine VM46 is IP₂, the load distribution is possible, as illustrated in FIG. 19.

### (B4) Third Pattern

In a third pattern, a case where the VNF 12 which is the target of the load distribution is the relay-type load balancer, but the VNF 12 that transfers the packet to the VNF 12 which is the target of the load distribution is the termination-type will be described.

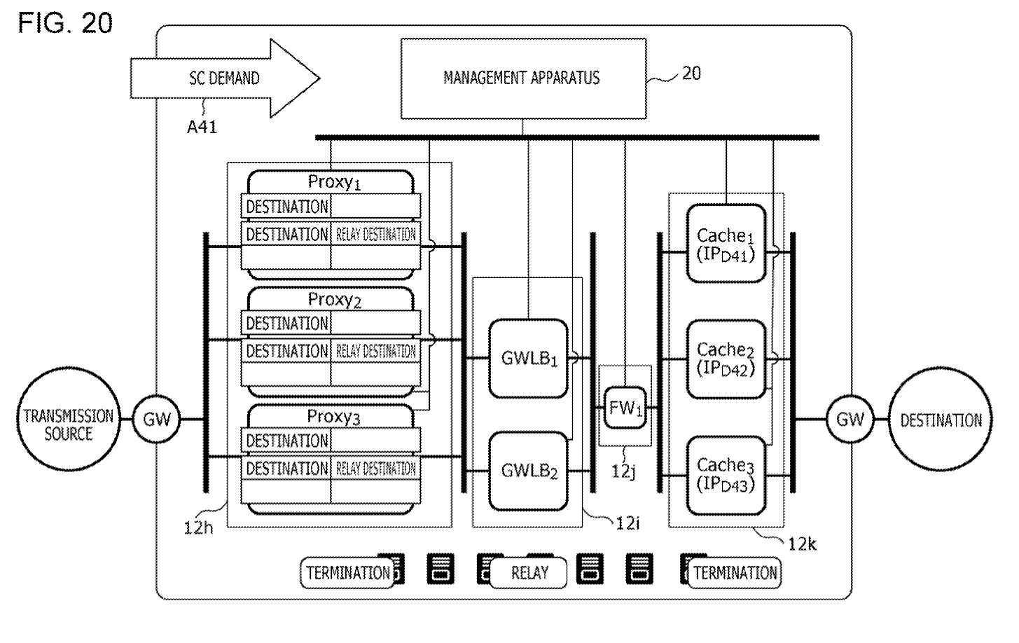

FIG. 20 is a diagram illustrating an example of the service chain to which the third pattern is applied. The service chain illustrated in FIG. 20 includes VNFs 12h to 12k. In the following description, the VNF 12h operates as a proxy, and the VNF 12i operates as a gateway-type load balancer. The VNF 12j operates as a firewall, and the VNF 12k operates as a cache. The VNF 12h includes three virtual machines of the Proxy₁ to the Proxy₃, the VNF 12i includes two virtual machines of the GWLB₁ and the GWLB₂, and the VNF 12j includes the FW₁. The VNF 12k includes three virtual machines of the Cache₁ to the Cache₃.

In the example of FIG. 20, the reception unit 23 receives a service chain demand (arrow A41) which is used in the third pattern, thereby, the management apparatus 20 generates the service chain illustrated in FIG. 20.

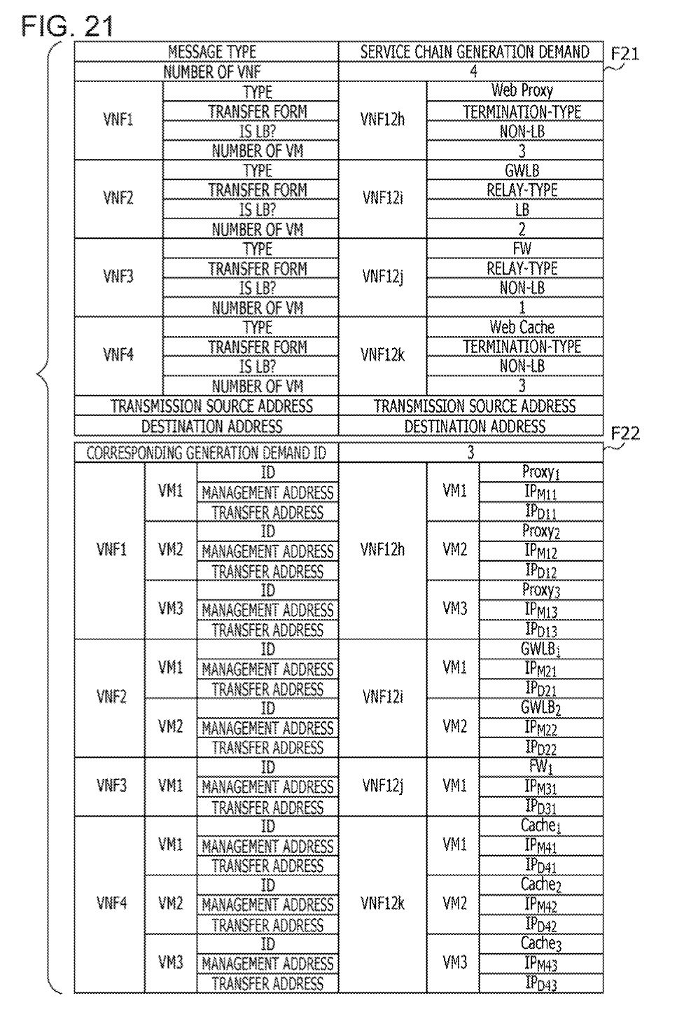

F21 of FIG. 21 is an example of the service chain demand transmitted by the arrow A41. In F21, in a sequence which is close to the transmission source device, the generating of four VNFs 12 of the VNF 12h, the VNF 12i, the VNF 12j, and the VNF 12k is demanded, and the information of each VNF 12 is included. The information of the VNF 12h is recorded as a VNF 1. The VNF 12h operates as a Web Proxy, and the transfer form is the termination-type. It is determined that the VNF 12h is not the load balancer (non-LB), and the number of VMs is 3. The information of the VNF 12i is recorded as a VNF 2. The VNF 12i operates as a load balancer, and the transfer form is the relay-type. The determination result regarding the VNF 12i is to be the load balancer (LB), and the number of VMs of the VNF 12i is 2. The information of the VNF 12j is recorded as a VNF 3. The VNF 12j operates as a firewall, and the transfer form is the relay-type. The determination result regarding the VNF 12j is not to be the load balancer (non-LB), and the number of VMs of the VNF 12j is 1. The information of the VNF 12k is recorded as a VNF 4. The VNF 12k operates as a Web Cache, and the transfer form is the termination-type. The determination result regarding the VNF 12k is not to be the load balancer (non-LB), and the number of VMs of the VNF 12k is 3.

If the information illustrated in F21 of FIG. 21 is obtained, the obtaining unit 31 stores the obtained information in the service chain demand information 41 by associating the obtained information with the information as the generation demand ID=3.

The VM deploying unit 32 generates the virtual machine, and performs the setting, by the same processing as the processing described in the first pattern, and records the information of the service chain in the network management table 42. In the drawing of the virtual machine illustrated in FIG. 20, the ID which is determined with respect to each virtual machine is written.

F22 of FIG. 21 is an example of the network management table 42. Hereinafter, the addresses assigned to each of the virtual machines which are included in the VNF 12h to the VNF 12k are illustrated in F22. For example, in the virtual machine Proxy₁ of the VNF 12h, the management address is IP_{M11}, and the transfer address is IP_{D11}. In the virtual machine Cache₁ which is included in the VNF 12k, the management address is IP_{M41}, and the transfer address is IP_{D41}.

The specifying unit 34 specifies the VNF 12 including the plurality of load balancers which become the targets of the load distribution, by the same processing as the processing described with reference to FIG. 7 and FIG. 8. In the example of the network illustrated in FIG. 20, the specifying unit 34 specifies the VNF 12i as a processing target, with reference to the service chain demand information 41 including the information illustrated in F21 of FIG. 21. At this time, the specifying unit 34 also specifies that the VNF 12i is the relay-type. The specifying unit 34 refers to the transfer form of the VNF 12 which is closer to the transmission source device than the VNF 12i of the processing target, in the information of the service chain demand information 41. In F21 of FIG. 21, since the VNF 12h which is closer to the transmission source device than the VNF 12i is the termination-type, the specifying unit 34 determines that the virtual machine in the VNF 12h generates the packet which is relayed by the VNF 12i. Furthermore, the specifying unit 34 specifies the VNF 12 that terminates the packet which is relayed by the VNF 12i, by referring to the transfer form of the VNF 12 which is closer to the destination device than the VNF 12i of the processing target. In F21 of FIG. 21, since the VNF 12k which is closer to the destination device than the VNF 12i is the termination-type, the specifying unit 34 determines that the packet which is relayed by the virtual machine in the VNF 12i is terminated by the VNF 12k. The specifying unit 34 notifies the determining unit 35 of the obtained result.

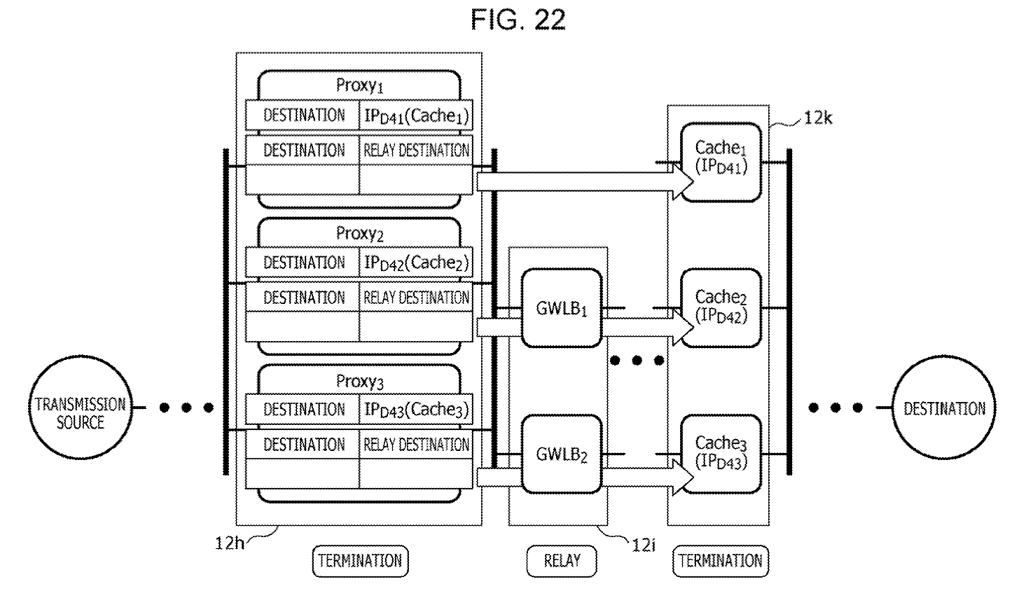

FIG. 22 is a diagram illustrating an example of the assignment method of the destination of the packet. FIG. 22 illustrates a case where the VNF 12h, the VNF 12i, and the VNF 12k are extracted from the service chain of FIG. 20. By using the service chain demand information 41, the determining unit 35 recognizes that three virtual machines of the Proxy₁ to the Proxy₃ are included in the VNF 12h, and two virtual machines of the GWLB₁ and the GWLB₂ are included in the VNF 12i. The determining unit 35 also specifies that the three virtual machines of the Cache₁ to the Cache₃ are included in the VNF 12k.

First, the determining unit 35 selects the destinations of the packets generated by the Proxy₁ to the Proxy₃ so as to minimize the difference between the processing loads of the virtual machines in the VNF 12k. In the example of FIG. 22, the determining unit 35 sets the destination of the packet generated by the Proxy₁ into the Cache₁, and sets the destination of the packet generated by the Proxy₂ into the Cache₂. The determining unit 35 sets the destination of the packet generated by the Proxy₃ into the Cache₃. Therefore, the determining unit 35 determines the destination of the packet generated by the Proxy₁ as IP_{D41}, the destination of the packet generated by the Proxy₂ as IP_{D42}, and the destination of the packet generated by the Proxy₃ as IP_{D43}. If the determining unit 35 outputs the information of the determined destination to the channel setting unit 36, the channel setting unit 36 sets the destination of the packet which is generated in the virtual machine thereof, into each virtual machine in the VNF 12h.

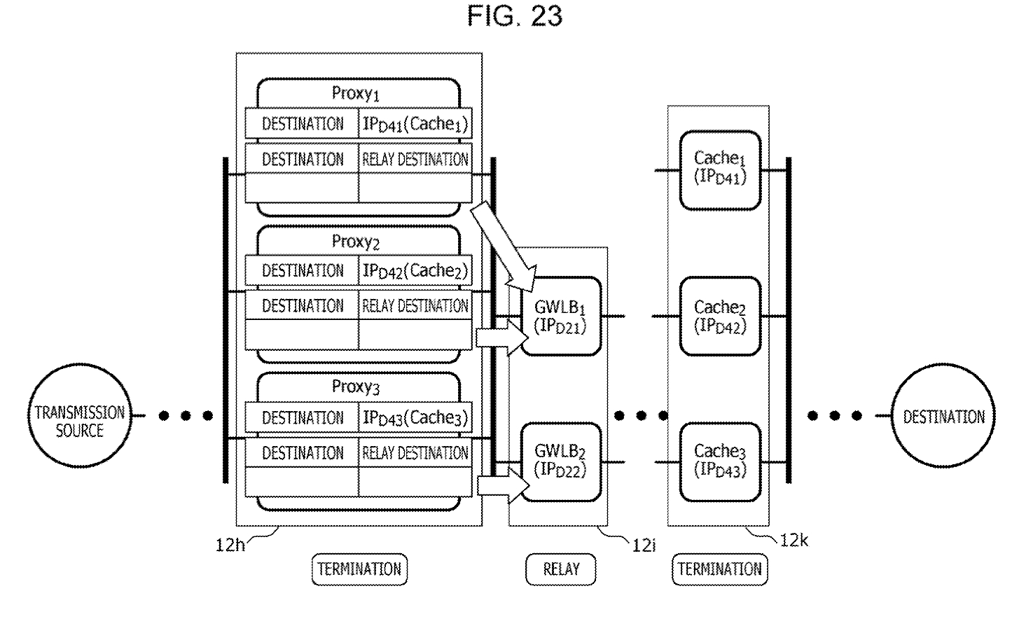

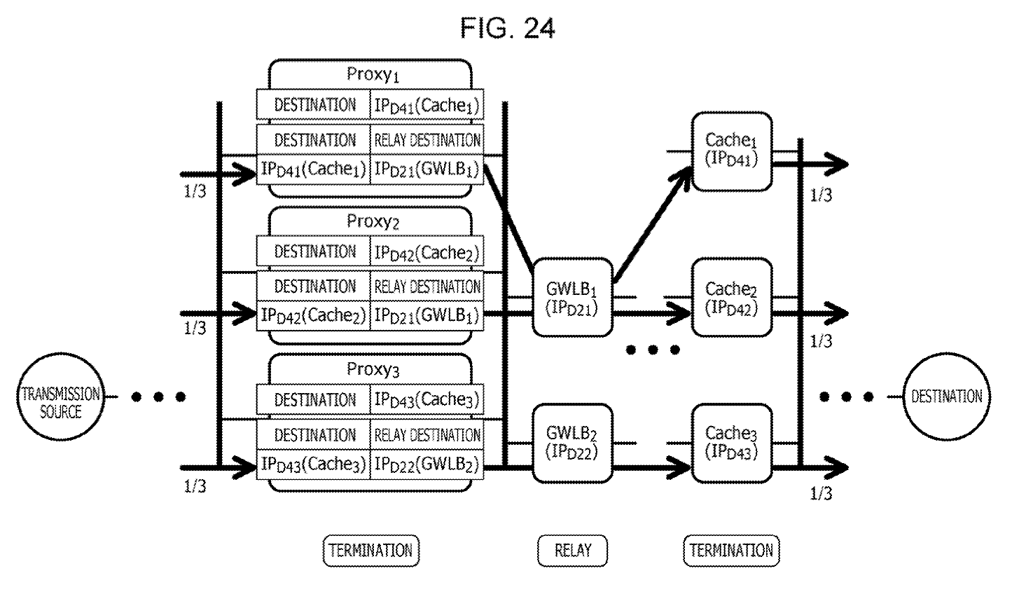

FIG. 23 is a diagram illustrating an example of the assignment method of the transfer destination. With reference to FIG. 23, an example of the processing that is performed when the determining unit 35 determines the transfer destination of the packet from the VNF 12h to the VNF 12i will be described. The determining unit 35 determines the transfer destinations of the packets generated by the Proxy₁ to the Proxy₃ so as to minimize the difference between the processing loads of the GWLB₁ and the GWLB₂. In the example of FIG. 23, the determining unit 35 determines that the transfer destinations of the packets generated by the Proxy₁ and the Proxy₂ are set into the GWLB₁, and the transfer destination of the packet generated by the Proxy₃ is set into the GWLB₂. Therefore, the determining unit 35 determines the transfer destinations of the packets generated by the Proxy₁ and the Proxy₂ as IP_{D21}, and determines the transfer destination of the packet generated by the Proxy₃ as IP_{D22}. The determining unit 35 outputs the determined information to the channel setting unit 36, and the channel setting unit 36 sets the information which is obtained from the determining unit 35 into the Proxy₁ to the Proxy₃ in the VNF 12h. FIG. 24 illustrates the information which is retained by the Proxy₁ to the Proxy₃ in the VNF 12h after the setting by the channel setting unit 36.

FIG. 24 is a diagram illustrating a setting example of the channel information. In addition to the processing described with reference to FIG. 22 and FIG. 23, the determining unit 35 determines the information of the routing tables of the GWLB₁ and the GWLB₂ in the VNF 12i, and the channel setting unit 36 performs the setting processing of the routing table. In the examples of FIG. 22 and FIG. 23, the GWLB₁ performs a relay processing of the packet which is generated by the Proxy₁ and is addressed to the Cache₁, and the packet which is generated by the Proxy₂ and is addressed to the Cache₂. Therefore, in the routing table retained by the GWLB₁, the following information is retained.
Destination 1:IP_{D41}
Relay destination of the packet addressed to the destination 1:IP_{D41}
Destination 2:IP_{D42}
Relay destination of the packet addressed to the destination 2:IP_{D42}
   Similarly, in the routing table retained by the GWLB₂, the following information is retained.
Destination 1:IP_{D43}
Relay destination of the packet addressed to the destination 1:IP_{D43}

The Proxy₁ to the Proxy₃ perform the generating and the transferring of the packets, in accordance with the destination information and the routing table of the packets which are set into the Proxy₁ to the Proxy₃. The GWLB₁ and the GWLB₂ also transfer the packets in accordance with the routing tables which are set into the GWLB₁ and the GWLB₂. Therefore, a transfer channel which is indicated by a bold arrow of FIG. 24 is generated. That is, the packet which is generated by the Proxy₁ and is addressed to the Cache₁, arrives at the Cache₁ through the GWLB₁. The packet which is generated by the Proxy₂ and is addressed to the Cache₂, arrives at the Cache₂ through the GWLB₁. The packet which is generated by the Proxy₃ and is addressed to the Cache₃, arrives at the Cache₃ through the GWLB₂.

Here, in a case where the difference of the amounts of the data which is transmitted from the transmission source may be neglected between the Proxy₁ and the Proxy₃, the amount of the data which is obtained from the transmission source by each of the Proxy₁ to the Proxy₃ is ⅓ of the amount of the data transmitted from the transmission source, one by one. Therefore, the data which is processed by the GWLB₁ is approximately ⅔ of the transmitted data, and the data which is processed by the GWLB₂ is approximately ⅓ of the transmitted data. In this manner, even in the VNF 12 including the plurality of virtual machines which operate as a relay-type load balancer, the load is distributed by performing the processing described in the third pattern.

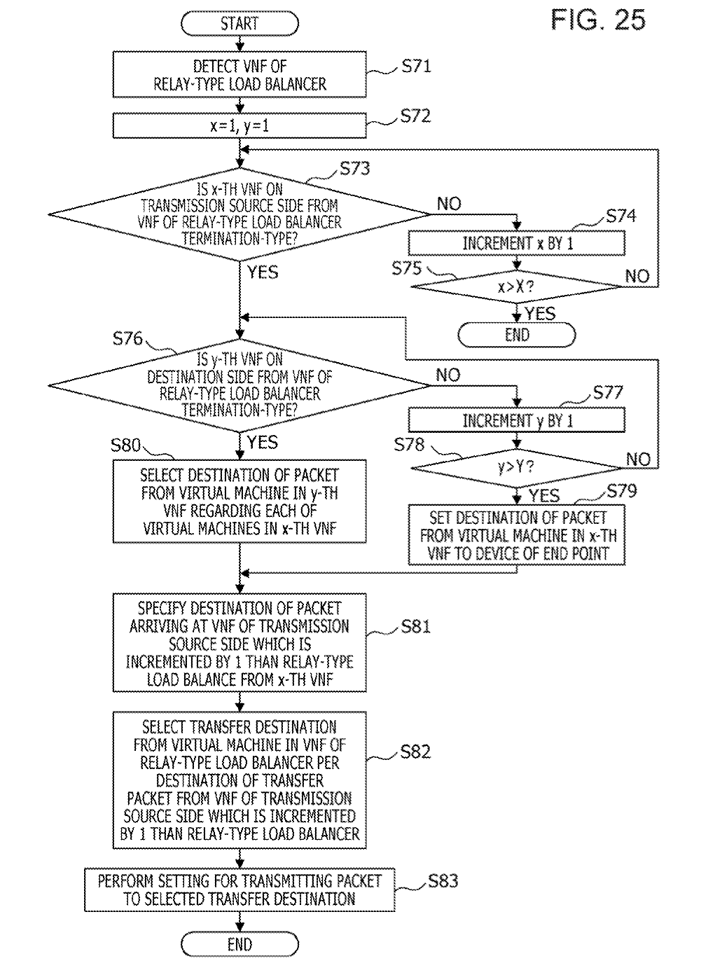

FIG. 25 is a flowchart illustrating an example of a control method for performing the load distribution. In FIG. 25, a constant X, a constant Y, a variable x, and a variable y are used. The constant X is a total number of VNFs 12 that are included in a channel leading to the VNF 12 which operates as a relay-type load balancer which is detected as a target of the load distribution from the transmission source device. The constant Y is a total number of VNFs 12 that are included in a channel leading to the destination device from the VNF 12 which operates as a relay-type load balancer which is detected as a target of the load distribution. The variable xis used for counting the number of VNFs 12 which are determined whether to be the VNF 12 that performs the termination-type processing, among the VNFs 12 in the channel leading to the VNF 12 which operates as a relay-type load balancer from the transmission source device. The variable y is used for counting the number of VNFs 12 which are determined whether to be the VNF 12 that performs the termination-type processing, among the VNFs 12 in the channel leading to the destination device from the VNF 12 which operates as a relay-type load balancer.

The specifying unit 34 detects the VNF 12 which operates as a relay-type load balancer (operation S71). The specifying unit 34 sets the variable x to 1, and sets the variable y to 1 (operation S72). The specifying unit 34 determines whether an x-th VNF 12 on the transmission source device side from the VNF 12 of the relay-type load balancer is the termination-type (operation S73). In a case where the x-th VNF 12 on the transmission source device side from the VNF 12 of the relay-type load balancer is not the termination-type, the specifying unit 34 increments the variable x by 1 (No in operation S73, and operation S74). Furthermore, the specifying unit 34 determines whether the variable x is larger than the constant X (operation S75). In a case where the variable x is larger than the constant X, the specifying unit 34 ends the processing (Yes in operation S75). In a case where the variable x is equal to or less than the constant X, the specifying unit 34 repeats the processing after operation S73 (No in operation S75).

In a case where the x-th VNF 12 on the transmission source device side from the VNF 12 of the relay-type load balancer is the termination-type, the specifying unit 34 determines whether a y-th VNF 12 on the destination device side from the VNF 12 of the relay-type load balancer is the termination-type (operation S76). In a case where the y-th VNF 12 on the destination device side from the VNF 12 of the relay-type load balancer is not the termination-type, the specifying unit 34 increments the variable y by 1 (No in operation S76, and operation S77). Furthermore, the specifying unit 34 determines whether the variable y is larger than the constant Y (operation S78). In a case where the variable y is equal to or less than the constant Y, the specifying unit 34 repeats the processing after operation S76 (No in operation S78).

The y-th VNF 12 on the destination device side from the VNF 12 of the relay-type load balancer is the termination-type (Yes in operation S76). In this case, the determining unit 35 selects the destination of the packet from the virtual machines in the y-th VNF 12 on the destination device side from the relay-type load balancer, regarding each of the virtual machines in the x-th VNF 12 on the transmission source device side from the relay-type load balancer (operation S80). In a case where the processing of the operation S80 is performed, the packet which is generated by the x-th VNF 12 on the transmission source device side from the VNF 12 of the relay-type load balancer is terminated by the y-th VNF 12 on the destination device side from the VNF 12 of the relay-type load balancer.

On the other hand, in operation S78, it is determined that the variable y is larger than the constant Y (Yes in operation S78). In this case, the determining unit 35 sets the destination of the packet into the device of the end point on the destination side of the service chain, regarding each of the virtual machines in the x-th VNF 12 on the transmission source device side from the relay-type load balancer (operation S79).

After operation S80 or S79, the determining unit 35 specifies the destination of the packet that arrives at the virtual machine in the VNF 12 on the transmission source device side which is incremented by 1 than the relay-type load balancer, from the x-th VNF 12 on the transmission source device side from the VNF 12 of the relay-type load balancer (operation S81). The processing of operation S81 is a processing of specifying the destination of the packet that arrives at the virtual machine which transfers the packet to each of the virtual machines in the VNF 12 operating as a relay-type load balancer. Per destination of the transfer packet from the VNF 12 on the transmission source device side which is incremented by 1 than the relay-type load balancer, the determining unit 35 selects the transfer destination from the virtual machines in the VNF 12 which operates as a relay-type load balancer (operation S82). For example, the details of the processing in operation S82 may be performed in the same manner as the processing of FIG. 14. The channel setting unit 36 performs the setting for transmitting the packet, to the selected transfer destination (operation S83).

FIG. 25 is merely an example of the processing, and the sequence of the processing may be changed depending on implementation. For example, the processing of operations S76 to S80 may be performed before the processing of operations S73 to S75. Furthermore, the sequence of operations S71 and S72 may be optionally changed.

### (B5) Fourth Pattern

In a fourth pattern, a case where the VNF 12 which is the target of the load distribution is the relay-type load balancer, and the VNF 12 that transfers the packet to the VNF 12 which is the target of the load distribution is also the relay-type will be described.

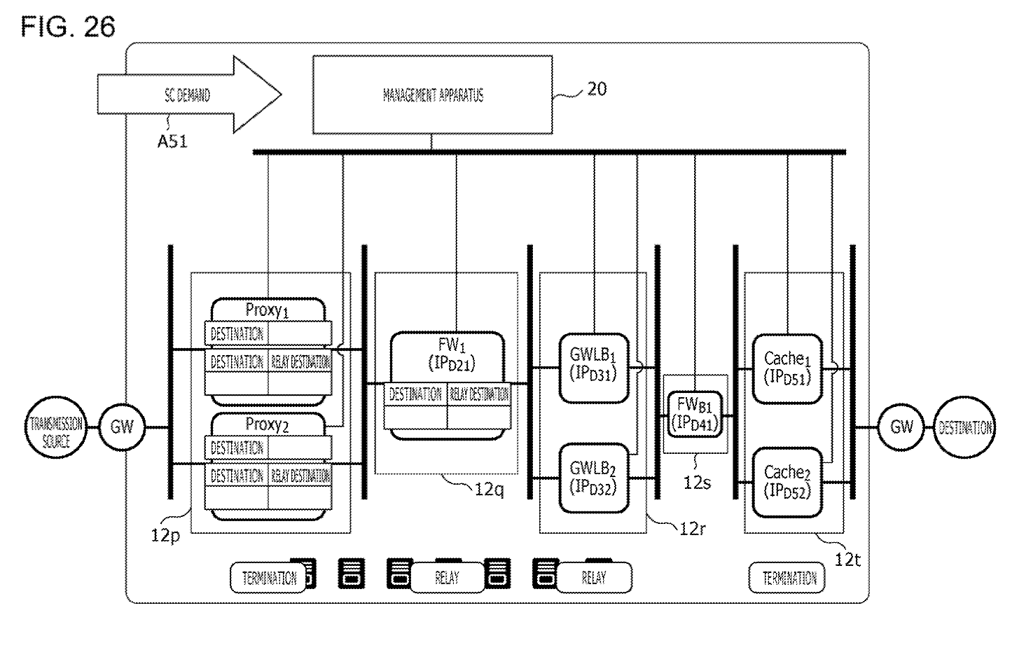

FIG. 26 is a diagram illustrating an example of the service chain to which the fourth pattern is applied. The service chain illustrated in FIG. 26 includes VNFs 12p to 12t. In the following description, the VNF 12p operates as a proxy, the VNF 12q operates as a firewall, and the VNF 12r operates as a gateway-type load balancer. The VNF 12s operates as a firewall, and the VNF 12t operates as a cache. The VNF 12p includes two virtual machines of the Proxy₁ and the Proxy₂, and the VNF 12q includes the FW₁. The VNF 12r includes two virtual machines of the GWLB₁ and the GWLB₂, and the VNF 12s includes a FW_{B1}. The VNF 12t includes two virtual machines of the Cache₁ and the Cache₂.

In the example of FIG. 26, the management apparatus 20 generates the service chain illustrated in FIG. 26 by receiving the service chain demand (arrow A 51) used in the fourth pattern by the reception unit 23.

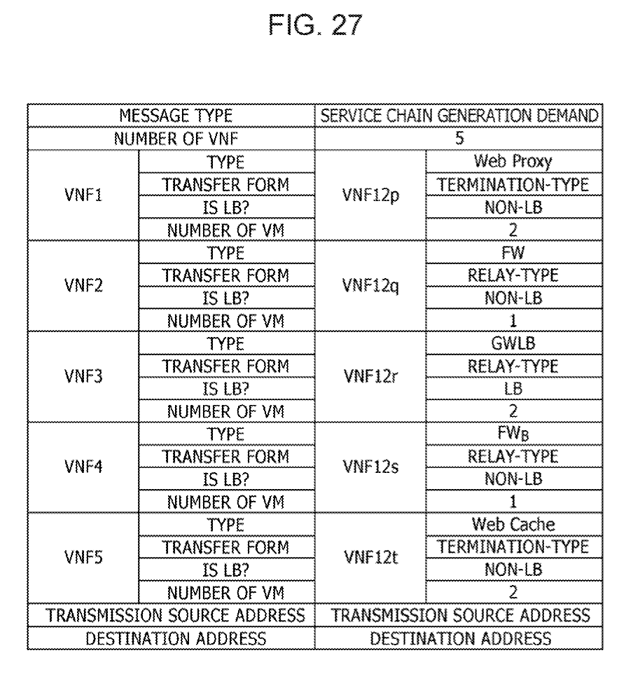

FIG. 27 is an example of the service chain demand transmitted by an arrow A51. In the service chain demand illustrated in FIG. 27, in a sequence which is close to the transmission source device, the generating of five VNFs 12 of the VNF 12p, the VNF 12q, the VNF 12r, the VNF 12s, and the VNF 12t is demanded, and the information of each VNF 12 is included. The information of the VNF 12p is recorded as a VNF 1. The VNF 12p operates as a Web Proxy, and the transfer form is the termination-type. It is determined that the VNF 12p is not the load balancer (non-LB), and the number of VMs of the VNF 12p is 2. The information of the VNF 12q is recorded as a VNF 2. The VNF 12q operates as a firewall, and the transfer form is the relay-type. The determination result regarding the VNF 12q is not to be the load balancer (non-LB), and the number of VMs of the VNF 12q is 1. The information of the VNF 12r is recorded as a VNF 3. The VNF 12r operates as a load balancer, and the transfer form is the relay-type. The determination result regarding the VNF 12r is to be the load balancer (LB), and the number of VMs of the VNF 12r is 2. The information of the VNF 12s is recorded as a VNF 4. The VNF 12s operates as a firewall, and the transfer form is the relay-type. The determination result regarding the VNF 12s is not to be the load balancer (non-LB), and the number of VMs of the VNF 12s is 1. The information of the VNF 12t is recorded as a VNF 5. The VNF 12t operates as a Web Cache, and the transfer form is the termination-type. It is determined that the VNF 12t is not the load balancer (non-LB), and the number of VMs of the VNF 12t is 2. If the information illustrated in FIG. 27 is obtained, the obtaining unit 31 stores the obtained information in the service chain demand information 41, in association with the information as the generation demand ID=4.

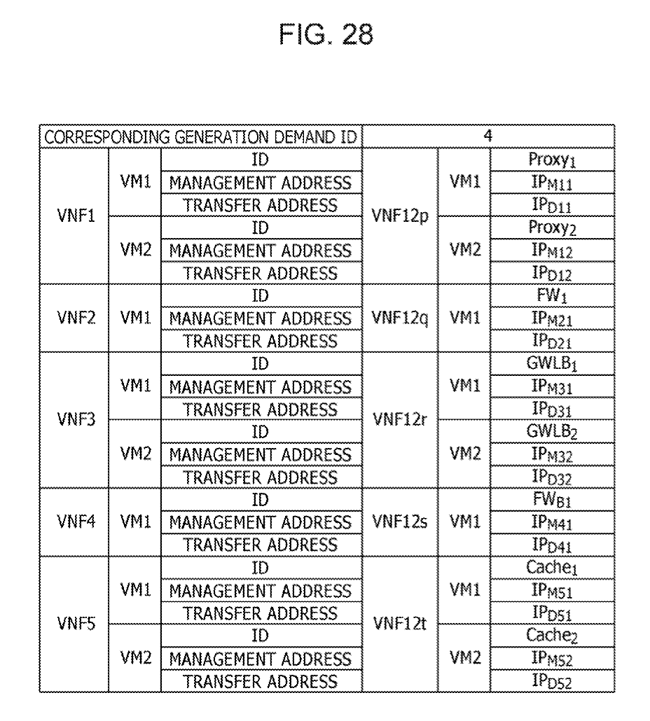

FIG. 28 is an example of the network management table 42 that is generated by using the information which is included in the service chain demand illustrated in FIG. 27. Hereinafter, the addresses assigned to each of the virtual machines which are included in the VNF 12p to the VNF 12t are illustrated in FIG. 28. For example, in the virtual machine Proxy₁ of the VNF 12p, the management address is IP_{M11}, and the transfer address is IP_{D11}. In the virtual machine Cache₁ which is included in the VNF 12t, the management address is IP_{M51}, and the transfer address is IP_{D51}.

The specifying unit 34 specifies the VNF 12 including the plurality of load balancers which become the target of the load distribution by the same processing as the processing described with reference to FIG. 7 and FIG. 8. In the example of the network illustrated in FIG. 26, the specifying unit 34 specifies the VNF 12r as a target of the load distribution processing, with reference to the service chain demand information 41 (FIG. 27). At this time, the specifying unit 34 also specifies that the VNF 12r is the relay-type. The specifying unit 34 specifies the VNF 12 that generates the packet which is relayed by the VNF 12r, and the VNF 12 that terminates the packet which is relayed by the VNF 12r, by the same processing as the processing which is described with reference to FIG. 21 in the description of the third pattern. In the example of FIG. 27, the packet which is relayed by the VNF 12r is generated by the VNF 12p, and is terminated by the VNF 12t. The specifying unit 34 notifies the determining unit 35 of the obtained result.

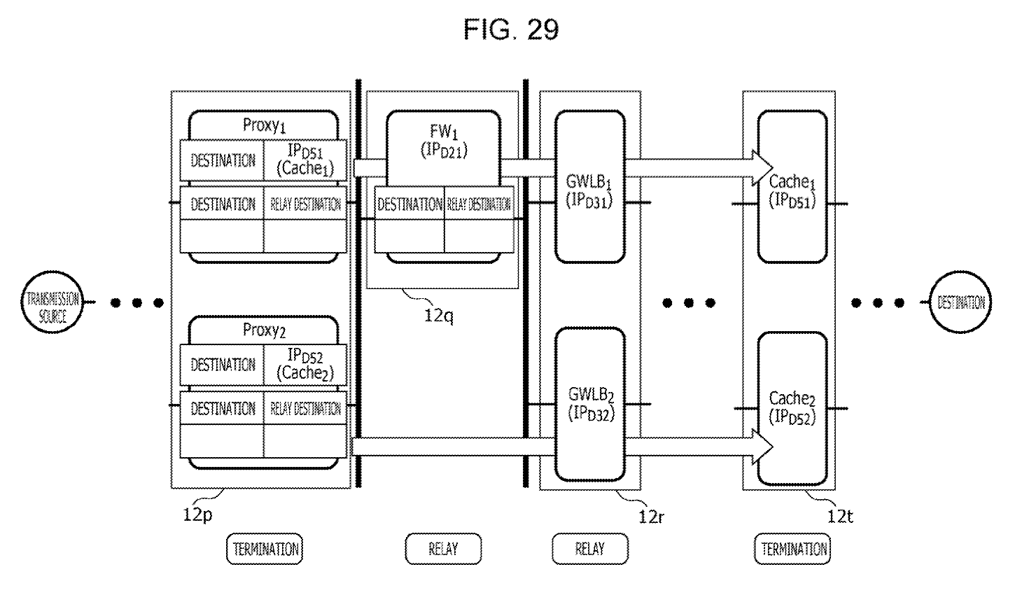

FIG. 29 is a diagram illustrating an example of the assignment method of the destination of the packet. FIG. 29 illustrates a case where the VNF 12p, the VNF 12q, the VNF 12r, and the VNF 12t are extracted from the service chain of FIG. 26. By using the service chain demand information 41, the determining unit 35 recognizes that two virtual machines of the Proxy₁ and the Proxy₂ are included in the VNF 12p, the FW₁ is included in the VNF 12q, and two virtual machines of the GWLB₁ and the GWLB₂ are included in the VNF 12r. The determining unit 35 also specifies that the two virtual machines of the Cache₁ and the Cache₂ are included in the VNF 12t.

First, the determining unit 35 selects the destinations of the packets generated by each of the Proxy₁ and the Proxy₂ so as to minimize the difference between the processing loads of the virtual machines in the VNF 12t. In the example of FIG. 29, the determining unit 35 sets the destination of the packet generated by the Proxy1 into the Cache₁, and sets the destination of the packet generated by the Proxy2 into the Cache₂. In this case, the determining unit 35 determines the destination of the packet generated by the Proxy₁ as IP_{D51}, and the destination of the packet generated by the Proxy₂ as IP_{D52}. If the determining unit 35 outputs the information of the determined destination to the channel setting unit 36, the channel setting unit 36 sets the destination of the packet which is generated in the virtual machine thereof into each virtual machine in the VNF 12p. Therefore, the setting of the virtual machine in the VNF 12p is made as illustrated in FIG. 29.

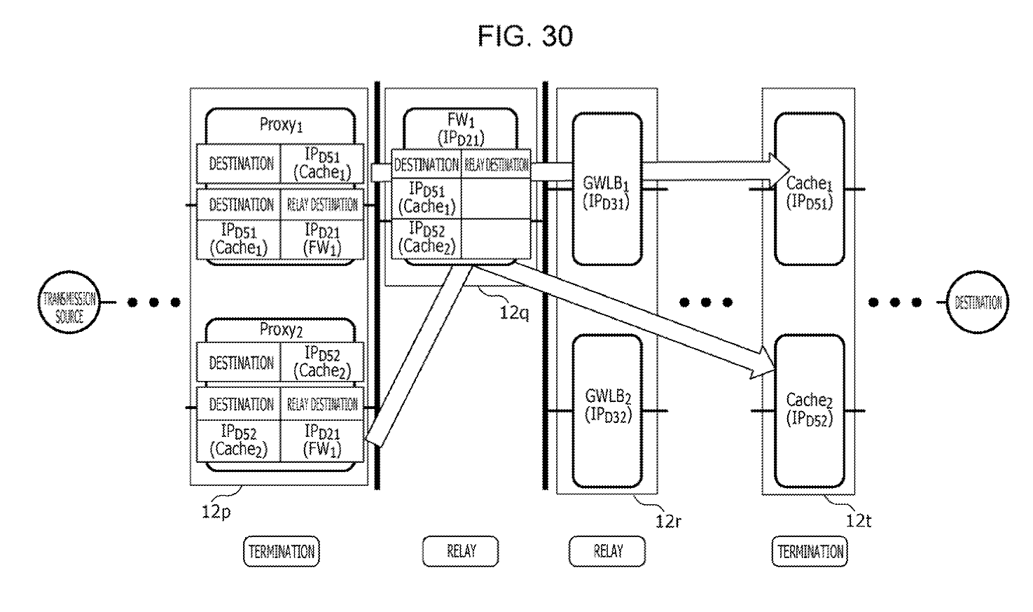

FIG. 30 is a diagram illustrating an example of the assignment method of the transfer destination of the packet. With reference to FIG. 30, an example of the processing that is performed when the determining unit 35 determines the transfer destination of the packet from the VNF 12p to the VNF 12q will be described. Since the virtual machine which is included in the VNF 12q is one, the determining unit 35 determines the transfer destination of the packet which is generated by the Proxy₁ and is addressed to the Cache₁ into the FW₁. The determining unit 35 also determined the transfer destination of the packet which is generated by the Proxy₂ and is addressed to the Cache₂ into the FW₁. In other words, the determining unit 35 determines the transfer destination of the packets which are generated by both of the Proxy₁ and the Proxy₂ as IP_{D21}. FIG. 30 illustrates the information that is retained by each virtual machine, in a case where the information determined by the determining unit 35 is set into the virtual machine.

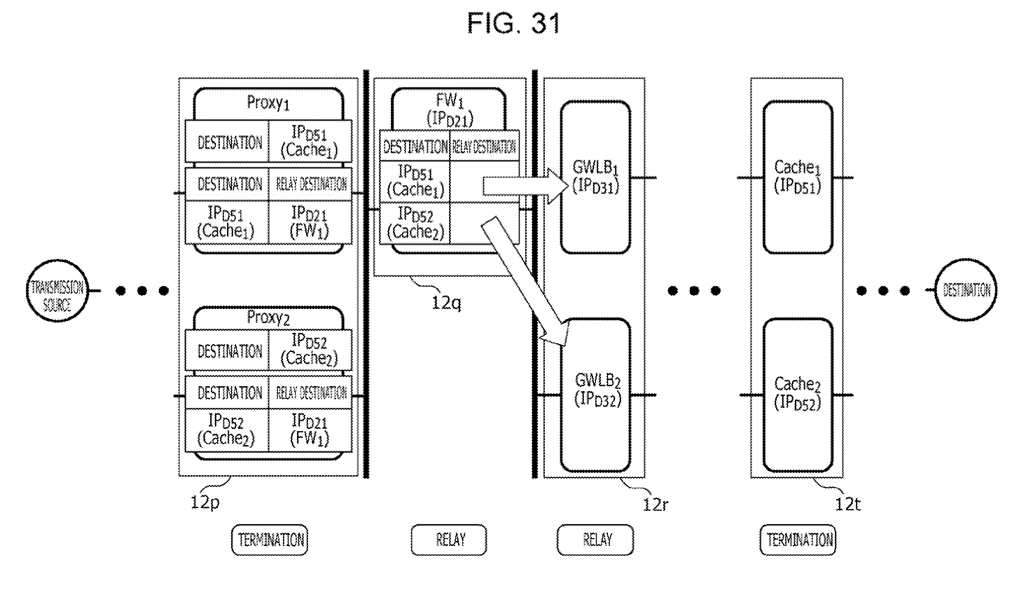

FIG. 31 is a diagram illustrating an example of the assignment method of the transfer destination of the packet. With reference to FIG. 31, an example of the processing that is performed when the determining unit 35 determines the transfer destination of the packet from the VNF 12q to the VNF 12r will be described. The determining unit 35 determines the transfer destination of the packet from the FW₁ so as to minimize the difference between the processing loads of the GWLB₁ and the GWLB₂ in the VNF 12r. In the example of FIG. 31, the determining unit 35 determines that the destination of the packet addressed to the Cache₁ is set into the GWLB₁, and the destination of the packet addressed to the Cache₂ is set into the GWLB₂. Therefore, the determining unit 35 determines the information that is included in the routing table used in the FW₁ as follows.
Destination 1:IP_{D51}
Relay destination of the packet addressed to the destination 1:IP_{D31}
Destination 2:IP_{D52}
Relay destination of the packet addressed to the destination 2:IP_{D32}
   The determining unit 35 outputs the determined information to the channel setting unit 36, and the channel setting unit 36 sets the information which is obtained from the determining unit 35 into the FW₁ in the VNF 12q.

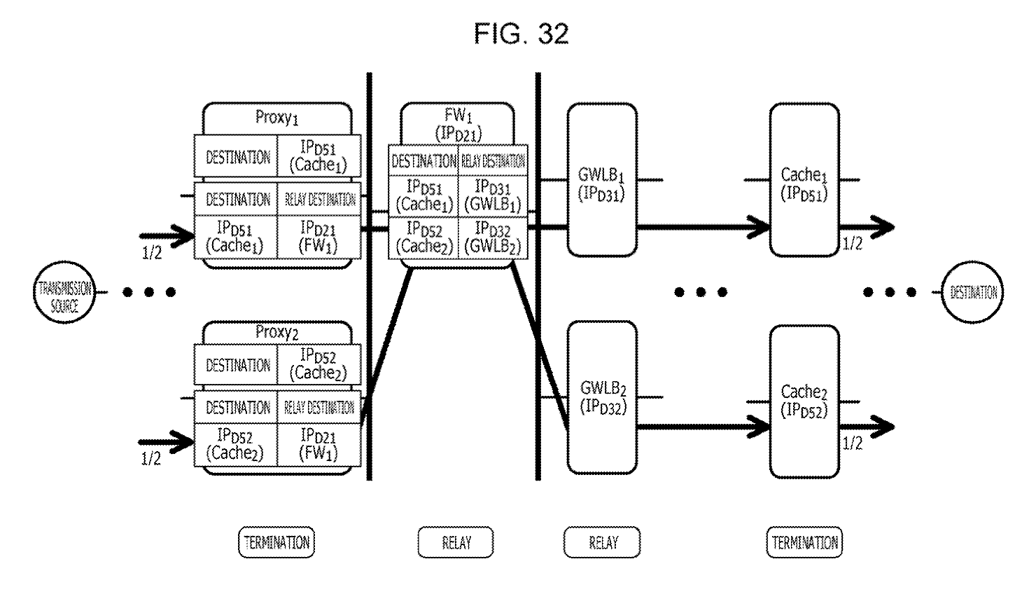

FIG. 32 is a diagram illustrating an example of the transfer channel that is obtained in a case where the setting described with reference to FIG. 29 to FIG. 31 is performed. In addition to the processing described with reference to FIG. 29 to FIG. 31, the determining unit 35 determines the information of the routing tables of the GWLB₁ and the GWLB₂ in the VNF 12r, and the channel setting unit 36 also performs the setting processing of the routing table. In the example described with reference to FIG. 29 to FIG. 31, since the GWLB₁ performs the relay processing of the packet which is generated by the Proxy₁ and is addressed to the Cache₁, the following information is retained in the routing table which is retained by the GWLB₁.
Destination 1:IP_{D51}
Relay destination of the packet addressed to the destination 1:IP_{D41}
   Similarly, in the routing table which is retained by the GWLB₂, the following information is retained.
Destination 1:IP_{D52}
Relay destination of the packet addressed to the destination 1:IP_{D41}
   Furthermore, the following information is retained in the routing table which is retained by the FW_{B1} in the VNF 12s.
Destination 1:IP_{D51}
Relay destination of the packet addressed to the destination 1:IP_{D51}
Destination 2:IP_{D52}
Relay destination of the packet addressed to the destination 2:IP_{D52}

The Proxy₁ and the Proxy₂ perform the generating and the transferring of the packets, in accordance with the destination information and the routing tables of the packets which are set into the Proxy₁ and the Proxy₂. Each virtual machine in the service chain also transfers the packet in accordance with the routing table which is set into each virtual machine. Therefore, the transfer channel which is indicated by a bold arrow of FIG. 32 is generated. That is, the packet which is generated by the Proxy₁ and is addressed to the Cache₁, arrives at the Cache₁ through the FW₁, the GWLB₁, and the FW_{B1}. The packet which is generated by the Proxy₂ and is addressed to the Cache₂, arrives at the Cache₂ through the FW₁, the GWLB₂, and the FW_{B1}.

Here, in a case where the amount of the data transmitted from the transmission source is substantially the same between the Proxy₁ and the Proxy₂, the amount of the data which is obtained from the transmission source by each of the Proxy₁ and the Proxy₃ is ½ of the amount of the data transmitted from the transmission source, one by one. Therefore, the data which is processed by the GWLB₁ becomes approximately ½ of the transmitted data, and the data which is processed by the GWLB₂ also becomes approximately ½ of the transmitted data. In this manner, even in the VNF 12 including the plurality of virtual machines which operate as a relay-type load balancer, the load is distributed by performing the processing described in the fourth pattern.

### (B6) Summary of Setting to Relay-Type Load Balancer

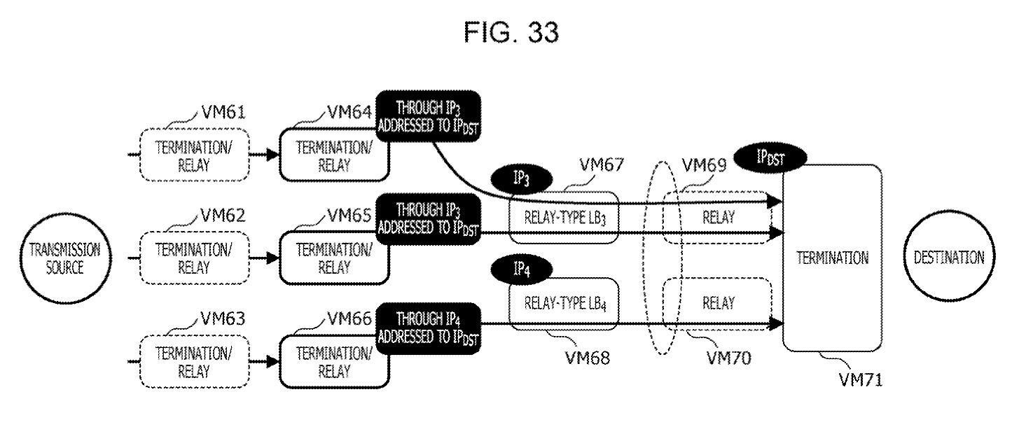

FIG. 33 is a diagram illustrating a setting example of the address in the distributed processing to the relay-type load balancer. FIG. 33 is an example of the service chain including the plurality of virtual machines VM61 to VM71. The VM61 to the VM63 are included in one VNF 12, and the VM64 to the VM66 are included in the other VNF 12. The VM67 and the VM68 are included in the VNF 12 which operates as a relay-type load balancer. Furthermore, the VM69 and the VM70 are included in one VNF 12. In FIG. 33, a virtual machine relating to the setting of the destination or the transfer destination at the time of the processing for the load distribution in the VNF 12 which includes the plurality of virtual machines and operates as a relay-type load balancer, is indicated by a solid line, and other virtual machines are indicated by dotted lines. Therefore, the VM67 and the VM68 which operate as a relay-type load balancer, and the VM71 that terminates the packet relayed through any of the VM66, the VM67, and the VM68 from the VM 64 that enables to transfer the packet to any of the VM67 and the VM68, are indicated by solid lines.

As described with reference to FIG. 19 to FIG. 32, by setting the transfer destination and the destination of the packet of the virtual machine in the VNF 12 that transfers the packet to the relay-type load balancer, the load distribution of the virtual machine in the VNF 12 which operates as a relay-type load balancer is possible. This is similarly applied to a case where the VNF 12 which is adjacent to the VNF 12 which operates as a relay-type load balancer is any of the termination-type and the relay-type. Therefore, by setting the transfer destination of the packet in the VM64 to the VM66 that enable to transfer the packets to the virtual machine which operates as a relay-type load balancer, the load distribution of the VM67 and the VM68 which operate as a load balancer is possible. At this time, the management apparatus 20 also sets the destinations of the packets transferred from the VM64 to the VM66 that enable to transfer the packets to the virtual machine which operates as a relay-type load balancer, by setting the termination-type device that generates the packet. Accordingly, in a case where the address assigned to the virtual machine VM67 is IP₃, and the address assigned to the virtual machine VM68 is IP₄, the load distribution is possible, as illustrated in FIG. 33.

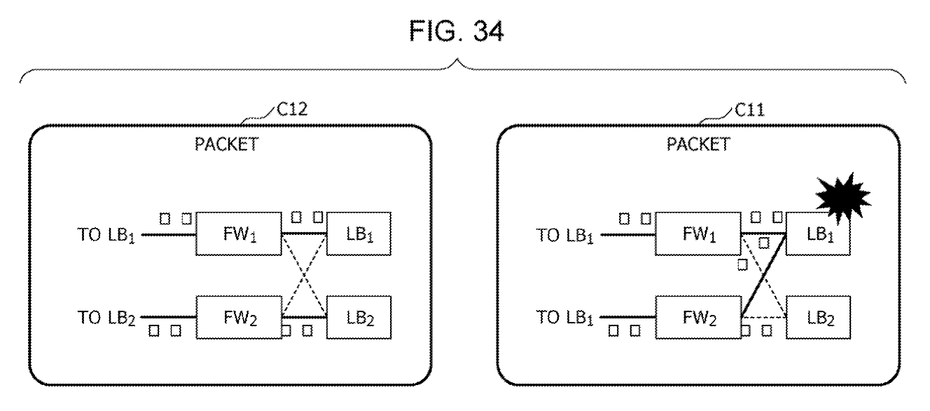

FIG. 34 is a diagram illustrating a comparative example of the load distribution by the method according to the embodiment with other methods. A case C12 is an example of a case where a load distribution method according to the embodiment is used, and a case C11 is an example of a case where other communication methods are used.

In the case C11, at the time of setting the destination of the packet that arrives at the virtual machines which operate as a plurality of load balancers, the destination of the packet is determined without considering which virtual machine is the load balancer which processes the packet. Therefore, for example, the load balancer is the termination-type, and the destination of the packet which is transferred from any of the firewalls FW₁ and FW₂ may be also set into a load balancer LB₁, as illustrated in the case C11. In this case, since the packet which is transferred from any of the firewalls FW₁ and FW₂ arrives at the load balancer LB₁, convergence occurs in the load balancer LB₁. Meanwhile, a use rate of a load balancer LB₂ becomes low. Accordingly, the efficiency of the system is poor.

A case C12 is an example of a case where the load distribution is performed by using the method according to the embodiment. If the method according to the embodiment is used, depending on whether the transfer form of the virtual machines which operate as a plurality of load balancers is the termination-type or the relay-type, it is determined whether the destination of the packet that arrives at the virtual machine which operates as a load balancer is set into the load balancer. Therefore, in a case where both of the load balancers LB₁ and LB₂ are the termination-type, the destination may be determined so that the load among the virtual machines which operate as a load balancer is distributed, in the virtual machine that generates the packet which is terminated by the load balancer. Therefore, as illustrated in the case C12, since the packet which is transferred from the firewall FW₁ arrives at the load balancer LB₁, and the packet which is transferred from the firewall FW₂ arrives at the load balancer LB₂, the load distribution among the load balancers is realized.

Although not illustrated in FIG. 34, in the method according to the embodiment, the transfer destination is determined so that the load among the load balancers is distributed, in each of the virtual machines which enable to transfer the packets to the relay-type load balancer. Therefore, even in a case where the plurality of virtual machines operate as a relay-type load balancer, the load may be efficiently distributed, by using the method according to the embodiment.

### Others

The embodiment is not limited to the above embodiments, and may be variously modified. Hereinafter, some examples thereof will be described.

In the description with reference to FIG. 22 or the like, in order to easily understood, a case where the channel setting unit 36 sets the information of the destination into the virtual machine if the determining unit 35 determines the destination of the packet is described, but the timing of the setting processing may be changed depending on implementation. For example, after the determining of the transfer destination in the determining unit 35 is completed, the setting processing may be performed with respect to each virtual machine from the channel setting unit 36, by using the control packet including both of the destination of the packet and the information of the transfer destination.

The service chain demand or the network management table 42 illustrated in the above description is merely an example. Depending on implementation, the information elements which are included in the service chain demand or the network management table 42 may be changed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management apparatus configured to manage a processing load on a virtual machine of a plurality of virtual machines forming a network, the management apparatus comprising:
a memory; and
a processor coupled to the memory and the processor configured to:
specify a plurality of first virtual machines to perform a load distribution processing from the plurality of virtual machines, based on a type of first processing performed by the virtual machine and a sequence of which the first processing is performed;
determine a destination of a transfer packet to be transferred to the plurality of first virtual machines at any of the plurality of first virtual machines, based on the processing load on the plurality of first virtual machines, in a case where the transfer packet is terminated by the plurality of first virtual machines; and
transmit a first control packet including information of the determined destination of the transfer packet to a virtual machine of the plurality of virtual machines which generates the transfer packet.

2. The management apparatus according to claim 1,
wherein the processor is configured to
determine the destination of the transfer packet in a virtual machine of the plurality of virtual machines which enables to perform a transfer processing to the plurality of first virtual machines so as to reduce a difference between processing loads among the plurality of first virtual machines, in a case where the transfer packet is transferred without being terminated by the plurality of first virtual machines, and
transmit a second control packet including information of the determined destination to the virtual machine of the plurality of virtual machines which enables to perform the transfer processing to the plurality of first virtual machines.

3. The management apparatus according to claim 2,
wherein the processor is configured to
specify one or more termination devices that terminate the transfer packet, in the case where the transfer packet is transferred without being terminated by the plurality of first virtual machines,
set, in the virtual machine of the plurality of virtual machines which generates the transfer packet, a destination of a packet transmitted from the virtual machine which generates the transfer packet into a terminal device selected from the one or more termination devices, and
select the destination of the transfer packet in the virtual machine of the plurality of virtual machines which enables to perform the transfer processing to the plurality of first virtual machines, from the plurality of first virtual machines according to a destination address set in the transfer packet.

4. The management apparatus according to claim 1,
wherein the processor is configured to, in a case where the transfer packet is terminated by the plurality of first virtual machines, and one or more relay devices that relay the transfer packet to the plurality of first virtual machines are included in a channel leading to the plurality of first virtual machines from the virtual machine of the plurality of virtual machines which generates the transfer packet, determine the destination of the transfer packet in each of one or more relay devices according to destination address set in the transfer packet.

5. A management method to manage a processing load on a virtual machine of a plurality of virtual machines forming a network, the management method comprising:
specifying a plurality of first virtual machines to perform a load distribution processing from the plurality of virtual machines, based on a type of first processing performed by the virtual machine and a sequence of which the first processing is performed;
determining a destination of a transfer packet to be transferred to the plurality of first virtual machines at any of the plurality of first virtual machines, based on the processing load on the plurality of first virtual machines, in a case where the transfer packet is terminated by the plurality of first virtual machines; and
transmitting a first control packet including information of the determined destination of the transfer packet to a virtual machine of the plurality of virtual machines which generates the transfer packet, by a processor.

6. The management method according to claim 5,
wherein the processor
determines the destination of the transfer packet in a virtual machine of the plurality of virtual machines which enables to perform a transfer processing to the plurality of first virtual machines so as to reduce a difference between processing loads among the plurality of first virtual machines, in a case where the transfer packet is transferred without being terminated by the plurality of first virtual machines, and
transmits a second control packet including information of the determined destination to the virtual machine of the plurality of virtual machines which enables to perform the transfer processing to the plurality of first virtual machines.

7. The management method according to claim 6,
wherein the processor
specifies one or more termination devices that terminate the transfer packet, in the case where the transfer packet is transferred without being terminated by the plurality of first virtual machines,
sets, in the virtual machine of the plurality of virtual machines which generates the transfer packet, a destination of a packet transmitted from the virtual machine which generates the transfer packet into a terminal device selected from the one or more termination devices, and
selects the destination of the transfer packet in the virtual machine of the plurality of virtual machines which enables to perform the transfer processing to the plurality of first virtual machines, from the plurality of first virtual machines according to a destination address set in the transfer packet.

8. The management method according to claim 5,
wherein the processor, in a case where the transfer packet is terminated by the plurality of first virtual machines, and one or more relay devices that relay the transfer packet to the plurality of first virtual machines are included in a channel leading to the plurality of first virtual machines from the virtual machine of the plurality of virtual machines which generates the transfer packet, determines the destination of the transfer packet in each of one or more relay devices according to destination address set in the transfer packet.

9. A computer-readable non-transitory recording medium storing a program that causes a computer to execute a procedure to manage a processing load on a virtual machine of a plurality of virtual machines forming a network, the procedure comprising:
specifying a plurality of first virtual machines to perform a load distribution processing from the plurality of virtual machines, based on a type of first processing performed by the virtual machine and a sequence of which the first processing is performed;
determining a destination of a transfer packet to be transferred to the plurality of first virtual machines at any of the plurality of first virtual machines, based on the processing load on the plurality of first virtual machines, in a case where the transfer packet is terminated by the plurality of first virtual machines; and
transmitting a first control packet including information of the determined destination of the transfer packet to a virtual machine of the plurality of virtual machines which generates the transfer packet, by a processor.

10. The computer-readable non-transitory recording medium according to claim 9,
wherein the procedure includes
determining the destination of the transfer packet in a virtual machine of the plurality of virtual machines which enables to perform a transfer processing to the plurality of first virtual machines so as to reduce a difference between processing loads among the plurality of first virtual machines, in a case where the transfer packet is transferred without being terminated by the plurality of first virtual machines, and
transmitting a second control packet including information of the determined destination to the virtual machine of the plurality of virtual machines which enables to perform the transfer processing to the plurality of first virtual machines.

11. The computer-readable non-transitory recording medium according to claim 10,
wherein the procedure includes
specifying one or more termination devices that terminate the transfer packet, in the case where the transfer packet is transferred without being terminated by the plurality of first virtual machines,
setting, in the virtual machine of the plurality of virtual machines which generates the transfer packet, a destination of a packet transmitted from the virtual machine which generates the transfer packet into a terminal device selected from the one or more termination devices, and
selecting the destination of the transfer packet in the virtual machine of the plurality of virtual machines which enables to perform the transfer processing to the plurality of first virtual machines, from the plurality of first virtual machines according to a destination address set in the transfer packet.

12. The computer-readable non-transitory recording medium according to claim 9,
wherein the procedure includes, in a case where the transfer packet is terminated by the plurality of first virtual machines, and one or more relay devices that relay the transfer packet to the plurality of first virtual machines are included in a channel leading to the plurality of first virtual machines from the virtual machine of the plurality of virtual machines which generates the transfer packet, determining the destination of the transfer packet in each of one or more relay devices according to destination address set in the transfer packet.
